(19) United States
(12) Patent Application Publication
(10) Pub. No.: US 2016/0078582 A1
(43) Pub. Date: Mar. 17, 2016

(54) Sharing Media

(71) Applicant: Lineage Labs, Inc., Westford, MA (US)

(72) Inventors: Firdaus Bhathena, Andover, MA (US); Jeffrey Anuszczyk, Framingham, MA (US); Rakesh Godhani, North Andover, MA (US); David Chamberlain, New Boston, NH (US); Nancy Dussault Smith, South Weymouth, MA (US)

(73) Assignee: Lineage Labs, Inc., Westford, MA (US)

(21) Appl. No.: 14/847,311

(22) Filed: Sep. 8, 2015

Related U.S. Application Data
(60) Provisional application No. 62/049,753, filed on Sep. 12, 2014.

(51) Int. Cl. G06T 1/00; G06F 3/0488; G06F 3/0481; H04L 29/08

(52) U.S. Cl. CPC G06T 1/0007; H04L 67/18; G06F 3/0488; G06F 3/04817

(57) ABSTRACT

A method of operating a user device that has a user computing device, non-transitory memory, and a display screen. The method includes sending a data status to a remote computing device that identifies image data not previously stored on remote non-transitory memory in communication with the remote computing device. The method includes, displaying on the user display screen, one or more photos or videos representative of the identified image data, and receiving a storage command regarding storage of any of the displayed one or more photos or videos on the remote non-transitory memory. The method includes communicating the storage command from the user computing device to the remote computing device. The storage command instructs storage or non-storage of one or more photos or videos representative of the image data by the remote computing device on the remote non-transitory memory.

### CROSS REFERENCE TO RELATED APPLICATIONS

This U.S. patent application claims priority under 35 U.S.C. §119(e) to U.S. Provisional Application 62/049,753, filed on Sep. 12, 2014, which is hereby incorporated by reference in its entirety.

### TECHNICAL FIELD

This disclosure relates to media storage and sharing media between multiple users of multiple devices.

### BACKGROUND

Social media allows people to create, share, or exchange information and ideas in virtual communities or networks. Social media depends on mobile and web-based technologies to allow people to share, co-create, collaborate on, discuss, and modify user-generated content. One aspect of social media is photo sharing, which allows a user to transfer his/her personal digital photos online and share the photos with others, privately or publicly.

In recent years, use of computers, smartphones, and other Internet-connected devices has grown exponentially. Correspondingly, most of these devices include a camera that is capable of capturing photographs and videos (including audio). These camera phones are usually less complicated than a traditional camera (e.g., a digital camera); however, camera phones have greatly improved the quality of the pictures. Therefore, it is easy for a person to take a picture using a camera phone and share it with the world within a matter of seconds. As they say “a picture is worth a thousand words,” and photo sharing has become an important aspect of sharing information over social media.

### SUMMARY

One aspect of the disclosure provides a method of operating a user device (e.g., computer, portable electronic device, smartphone, tablet PC, cellular telephone, portable digital assistant, digital camera, digital video camera) having a user computing device, user non-transitory memory in communication with the user computing device, and a user display screen in communication with the user computing device. The method includes sending a data status to a remote computing device (e.g., a photo-sharing device), the data status identifying image data not previously stored on remote non-transitory memory in communication with the remote computing device, or receiving, at the user computing device, a communication from the remote computing device (e.g., a photo-sharing device) accessing the user non-transitory memory. The communication identifies image data (e.g., a photo and/or a video) stored on the user non-transitory memory not previously stored on remote non-transitory memory in communication with the remote computing device. The method also includes, displaying, using the user computing device, on the user display screen, one or more photos or videos representative of the identified image data, and receiving, at the user computing device, a storage command regarding storage of any of the displayed one or more photos or videos on the remote non-transitory memory. The method also includes communicating the storage command from the user computing device to the remote computing device, the storage command instructing storage or non-storage of one or more photos or videos representative of the image data by the remote computing device on the remote non-transitory memory.

Implementations of the disclosure may include one or more of the following features. In some implementations, the method includes receiving, at the user computing device, an indication of available connectivity to a communication network (e.g., a local network or a shared network), and establishing communication between the user computing device and the remote computing device through the communication network.

The method may also include receiving, at the user computing device, a request from the remote computing device to access image data stored on the user non-transitory memory. Additionally or alternatively, in some examples, the method may further include allowing the remote computing device to store the selected one or more photos or videos on the remote non-transitory memory, when the storage command contains a selection of one or more photos or videos for storage on the remote non-transitory memory.

In some examples, the method further includes disallowing the remote computing device to store the selected one or more photos or videos on the remote non-transitory memory, when the storage command contains a selection of one or more photos or videos for non-storage on the remote non-transitory memory. Additionally or alternatively, the storage command may instruct the remote computing device to alter the image data before storing the image data on the remote non-transitory memory. In some examples, the storage command instructs the remote computing device to alter image metadata of the identified image data before storing the image data on the remote non-transitory memory.

In some implementations, the method further includes receiving, at the user computing device, an image manipulation command for manipulating the identified image data stored on user non-transitory memory before allowing storage of the identified image data on the remote non-transitory memory. Additionally or alternatively, the method may include receiving, at the user computing device, sound data from an audio device in communication with the user computing device; receiving a selection of one or more photos or videos representative of the identified image data; and associating the sound data with the selected one or more photos or videos. The storage command instructs storage of the sound data and the identified image data on the remote non-transitory memory.

The method may also include receiving, at the user computing device, a selection of a photo or video and a touch gesture on the user display screen indicative of a swiping motion to move the selected one or more photos or videos to a remote display screen in communication with the remote computing device. The swiping motion may include a forward motion toward the remote display screen and away from the user device.

In some implementations, the method includes displaying, using the user computing device, on the user display screen a map view. The map view includes a map and a location icon overlaid at a location on the map and indicative of a number of photos or videos captured at the location.

The method may also include displaying, using the user computing device, on the user display screen photos or videos representative of image data stored on the user non-transitory memory and a storage state for each photo or video. The storage state indicating whether the photo or video is currently stored on the remote non-transitory memory.

Another aspect of the disclosure provides a method of operating a user device having a user computing device, user non-transitory memory in communication with the user computing device, and a touch screen in communication with the user computing device. The method optionally includes receiving, at the user computing device, a communication from a remote computing device. The communication includes image data stored on remote non-transitory memory in communication with the remote computing device. The method optionally includes sending a data status to a remote computing device (e.g., a photo-sharing device). The data status identifying image data not previously stored on remote non-transitory memory in communication with the remote computing device. The method also includes displaying, using the user computing device, photos or videos representative of the received image data on the touch screen, and receiving, at the user computing device, a selection of one or more photos or videos and a touch gesture on the touch screen indicative of a swiping motion to move the selected one or more photos or videos to a remote display in communication with the remote computing device. The method includes sending a display command from the user computing device to the remote computing device instructing the remote computing device to display the selected one or more photos or videos on the remote display.

In some implementations, the touch gesture includes a substantially linear swipe along the touch screen. The substantially linear swipe along the touch screen may include a linear swipe towards the remote display and away from the user device.

In some examples, the method also includes receiving, at the user computing device, sound data from an audio device in communication with the user computing device and receiving a selection of one or more photos or videos. The method also includes associating, using the user computing device, the sound data with the selected one or more photos or videos. The method may further include sending a storage command from the user computing device to the remote computing device instructing the remote computing device to store the sound data and the selected one or more photos or videos on the remote non-transitory memory. In some implementations, the method further includes sending a favorite command from the user computing device to the remote computing device instructing the remote computing device to associate a favorite tag with the selected one or more photos or videos.

In some implementations, the method may include, when displaying a video on the touch screen, displaying: a timeline indicative of a length of the video; a favorite start icon overlain on the timeline and indicating a start of a favorite portion of the video; and a favorite end icon overlain on the timeline and indicating and end of the favorite portion of the video, the favorite start icon and the favorite end icon indicating a favorite video portion of the video. The method may also include receiving, at the user computing device, a selection of a favorite start time on the timeline of the video, and overlaying the favorite start icon on the timeline at a time corresponding to the favorite start time. The method includes receiving, at the user computing device, a selection of a favorite end time on the timeline of the video, and overlaying the favorite end icon on the timeline at a time corresponding to the favorite end time. In some examples, the method includes sending a view favorite video command from the user computing device to the remote computing device instructing the remote computing device to display the favorite video portion on the remote display. Additionally or alternatively, the display command may instruct the remote computing device to display only the selected one or more photos or videos designated as favorite or public viewing on the remote display.

Another aspect of the disclosure provides a method of operating a user device having a user computing device, user non-transitory memory in communication with the user computing device, and a touch screen in communication with the user computing device. The method optionally includes receiving, at the user computing device, a communication from a remote computing device. The communication includes image data stored on remote non-transitory memory in communication with the remote computing device. The method optionally includes sending a data status to a remote computing device (e.g., a photo-sharing device). The data status identifying image data not previously stored on remote non-transitory memory in communication with the remote computing device. The method also includes displaying, using the user computing device, photos or videos representative of the received image data on the touch screen, and displaying one or more collection glyphs indicative of collections of image data on the touch screen. The method includes receiving, at the user computing device, a selection of one or more photos or videos and a touch gesture on the touch screen indicative of a swiping motion to move the selected one or more photos or videos to a collection of image data, and sending a command from the user computing device to the remote computing device instructing the remote computing device to associate a collection with the image data corresponding to the selected one or more photos or videos.

In some implementations, the method includes displaying with each photo or video any collection tags currently associated with the photo or video. The collections includes at least one of: a location collection for photos or videos captured at a similar geolocation; a favorite collection for photos or videos designated as a user favorite; or a multi-device collection for photos or videos associated with multiple user devices.

In some examples, the method includes receiving, at the user computing device, a collection creation command, and sending the collection creation command from the user computing device to the remote computing device. The collection creation command instructs the remote computing device to generate and associate the collection with the image data corresponding to the selected one or more photos or videos. The method may include a command from the user computing device to the remote computing device instructing the remote computing device to associate a favorite tag with the selected one or more photos or videos.

Yet another aspect of the disclosure provides a method of operating a user device having a user computing device, user non-transitory memory in communication with the user computing device, and a user display screen in communication with the user computing device. The method optionally includes receiving, at the user computing device, a communication from a remote computing device. The communication includes image data stored on remote non-transitory memory in communication with the remote computing device. The method optionally includes sending a data status to a remote computing device (e.g., a photo-sharing device). The data status identifying image data not previously stored on remote non-transitory memory in communication with the remote computing device. The method includes displaying, using the user computing device, photos or videos representative of the received image data on the user display screen, and receiving sound data from an audio device in communication with the user computing device. The method also includes receiving, at the user computing device, a selection of one or more photos or videos representative of the received image data and associating, using the user computing device, the sound data with the selected one or more photos or videos. The method includes sending a display command from the user computing device to the remote computing device instructing the remote computing device to store the sound data and associated one or more photos or videos on the remote non-transitory memory.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary photo-sharing system allowing one or more users to share photos and videos over one or more networks.

FIG. 1B is a schematic view of the exemplary photo-sharing system allowing one or more users to share photos and videos over a home network.

FIG. 2A is a schematic view of an exemplary user device in communication with a photo-sharing device.

FIG. 2B is a schematic view of an exemplary method of detecting a photo-sharing device using a user device.

FIG. 2C is a schematic view of exemplary user devices capable of taking photos and videos and having a photo-sharing application.

FIG. 3 is a schematic view of an exemplary home, where each member of the home shares their photos using the photo-sharing system.

FIG. 4A is a schematic view of an exemplary view of a photo-sharing application.

FIG. 4B is a schematic view of an exemplary user display displaying a photo or video.

FIG. 4C is a schematic view of an exemplary timeline of a video allowing a user to select a portion of the video as a favorite.

FIG. 5A is a schematic view of an exemplary display displaying a favorites screen.

FIG. 5B is a schematic view of an exemplary display displaying a view all photos and videos screen.

FIG. 5C is a schematic view of an exemplary display displaying a create view allowing a user to create a collection or album.

FIG. 5D is a schematic view of an exemplary display displaying a create view allowing a user to enter the name of the collection or album.

FIG. 5E is a schematic view of an exemplary display displaying a search screen allowing a user to search for photos and videos to add to the created collection or album of FIG. 5D.

FIG. 5F is a schematic view of an exemplary display displaying a pictures and videos of a folder.

FIG. 6A is a schematic view of an exemplary display displaying a home screen.

FIG. 6B is a schematic view of an exemplary display displaying a places screen.

FIG. 6C is a schematic view of an exemplary display displaying a search screen.

FIG. 6D is a schematic view of an exemplary display displaying the search screen of FIG. 6C while the user is searching.

FIG. 6E is a schematic view of an exemplary display displaying the search results of the search of FIG. 6C.

FIG. 6F is a schematic view of an exemplary display displaying an adding description to a photo screen.

FIG. 6G is a schematic view of an exemplary display displaying a recent activity screen.

FIG. 7 is a schematic view of an exemplary display displaying an options screen.

FIG. 8 is a schematic view of an exemplary photo-sharing device.

FIGS. 9-12 are schematic views of an exemplary arrangement of operations for operating a user device for sharing photos and/or videos.

Like reference symbols in the various drawings indicate like elements.

### DETAILED DESCRIPTION

A photo sharing system of the present discloser implements photo sharing based on photos and videos received from one or more user devices. The photo sharing system receives one or more photo(s) and/or video(s), organizes the photo(s) and/or video(s), allows the user to share the photo(s) and/or video(s), protects the received photo(s) and/or video(s) (for example, by backing up the photo(s) and/or video(s) into a secondary non-transitory memory), and finally allows the user(s) to view the photo(s) and/or video(s) received from the one or more users. Therefore, a group of people living in the same household (e.g., a family of five), where each member of the group has one or more device(s), can share their photo(s) and/video(s) using the photo-sharing system. The photo sharing system allows multiple photo takers in one household to seemingly share photos between the members of the household. In addition, the photo sharing system provides an in-home photo sharing device that stores photos from all the members of the household in one location.

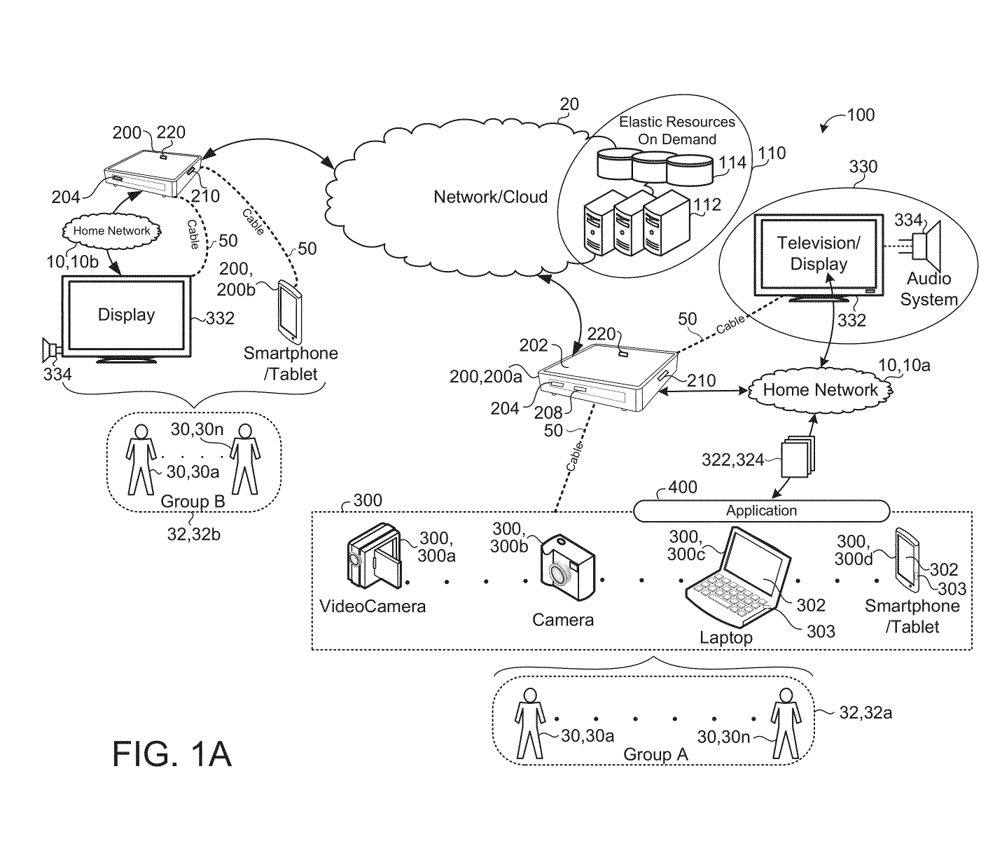

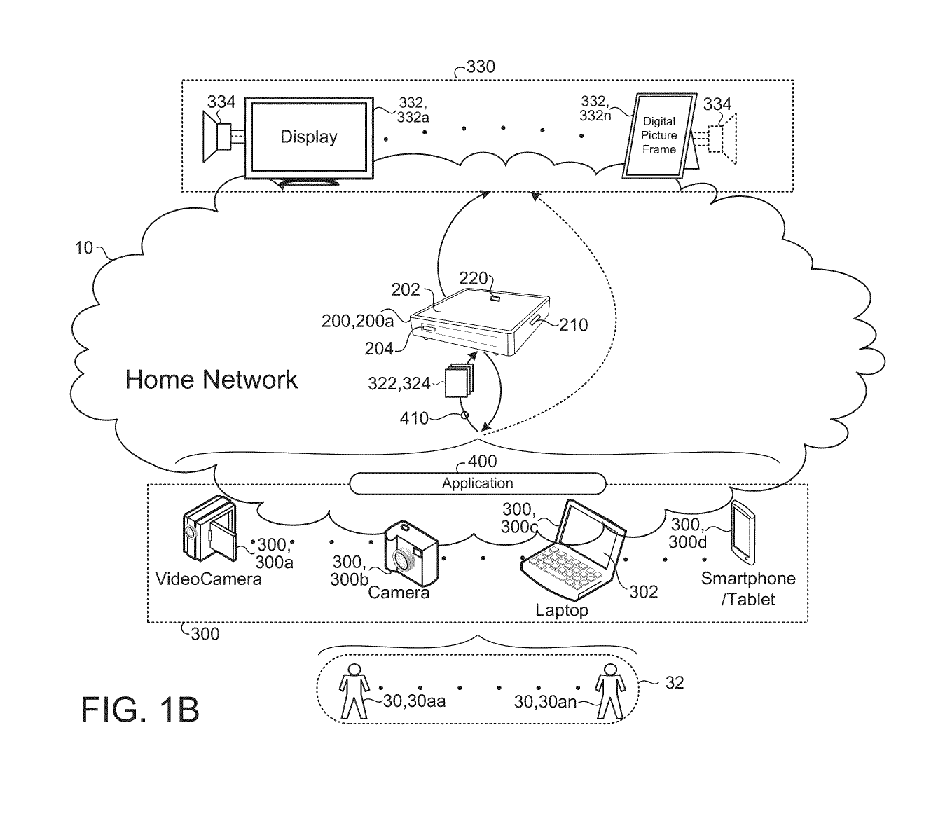

Referring to FIGS. 1A-1B, in some examples, the photo-sharing system 100 includes a photo-sharing device 200 capable of communicating with one or more user devices 300 (e.g., computer, portable electronic device, smartphone, tablet PC, cellular telephone, portable digital assistant, digital camera, digital video camera) associated with one or more users 30, one or more photo-sharing display system 330 (e.g., a display 332 in communication with an audio system 334 for outputting audio recordings), and/or one or more networks 10, 20. In some examples, the user device 300 executes a photo-sharing application 400 that allows each user device 300 to upload/download photos 322 and/or videos 324 (or other digital content) to the photo-sharing device 200. In other examples, a user 30 connects the user device 300 to the photo-sharing device 200 using a cable 50. The photo-sharing display system 100 may include one or more of a television display 332a, a digital photo frame 332n, or any other display 332 connected or not connected to an audio system 334.

In some implementations, a home network 10 provides communication between the photo-sharing device 200 and user devices 300 associated with users 30. The home network 10 may be a local area network (LAN) that allows smart devices and computers (such as the photo-sharing device 200, the user devices 300, or the display 330) to interconnect within a limited area (e.g., a home, a school, an office building). In some examples, the home network 10 is a home area network (HAN), which is a type of LAN facilitating communication and interoperability among smart devices located near or inside a home. Some of the technologies used for building LANs include, but are not limited to, ARCNET®, Token Ring, Ethernet (over twisted cables), and Wi-Fi (wireless).

The home network 10 may include one or more of a physical layer, a data link layer, and network layer connectivity, both internally between the devices and externally with a shared network 20. The home network 10 generally includes a modem, a router 12, the network switch, a wireless access point, and optionally network bridge. In some examples, an Internet service provider (ISP) provides a modem to a user 30, which allows the user 30 to connect user devices 300 to a shared network 20 (e.g., Wide Area Network (WAN)). In some examples, the user devices 300 are connected to the modem using an Ethernet interface. The router 12 manages network layer connectivity between the home network 10 and the shared network 20. In some examples, a network switch is used and allows devices 300 on the home network 10 to communicate with one another via is Ethernet. In some examples, the home network 10 does not include a network switch, and instead the router 12 includes a built-in switching capacity or the network includes Wi-Fi allowing for wireless connection between the devices 300. The home network 10 includes a wireless access point that connects the wireless devices to a shared network 20. In some examples, the wireless access point in integrated in the router 12. In some examples, a network bridge connects two network interfaces with one another. A network bridge is used to connect a wired device to a wireless network, allowing the device to communicate with other devices over the home network 10. The home network 10 may include a broadband modem, which is residential gateways that integrate the functions of a modem, network address translation (NAT) router, Ethernet switch, Wi-Fi access point, dynamic host configuration protocol (DHCP) server, and firewall, among others.

A user 30 may connect a user device 300 to the photo-sharing device 200 via a cable 50. The cable 50 may be any type of cable that supports uploading/downloading of photos 322 and/or videos 324 (or other digital content), or any type of cable that allows displaying on a display 332 pictures and video 324 (or other digital content), and outputting audio associated with the pictures and video 324 through an audio system 334. The cable 50 may include, but is not limited to, an HDMI (High-Definition Multimedia Interface) cable, USB (Universal Serial Bus), RCA (used between the photo-sharing device 200 and the display 332), or any other connectors. Moreover, the photo-sharing device 200 connects via a cable 50 (e.g., HDMI) to a display 332 (e.g., a television) in communication with an audio system 334 for outputting audio recording.

In some implementations, a first home network 10a communicates with a second home network via a shared network 20. The shared network 20 may be a wide area network (WAN) that covers a broad area and uses leased or private telecommunication lines. For example, the shared network 20 links networks across metropolitan, regional, national, or international boundaries. Therefore, the first and second home networks 10a, 10b may be in a different city, in a different state, on a different continent, or separated by an ocean and the shared network 20 is able to allow communication between the two home networks 10a, 10b.

The shared network 20 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The shared network 20 may include one or more of a Wide Area Network (WAN), a Local Area Network (LAN), and a Personal Area Network (PAN). In some examples, the shared network 20 includes a combination of data networks, telecommunication networks, and a combination of data and telecommunication networks. Additionally or alternatively, the shared network 20 provides access to cloud computing resources 110, which may be elastic/on-demand computing and/or storage resources available over the shared network 20. The term ‘cloud’ services generally refers to a service performed not locally on a user's device, but rather delivered from one or more remote devices accessible via one or more networks 20. The cloud computing resources 110 may be a distributed system (e.g., cloud environment) having scalable/elastic computing resources 114 and/or storage resources 114. In some examples, the photo-sharing device 200 receives photos 322 and/or videos 324 (or other digital content) from the user device 300 and stores the received photos 322 and/or videos 324 (or other digital content) in the non-transitory memory 220 (also known as memory hardware) of the photo-sharing device 200. Additionally, the photo-sharing device 200 may transmit a copy of the received photos 322 and/or videos 324 to the storage resources 114 of the cloud to create a copy of the photos, allowing a user 30 to retrieve the photos and/or videos if a user 30 accidentally deletes some or all the photos 322 and/or videos 324 from the memory 220 of the photo-sharing device 200.

The photo-sharing device 200 is a network device, i.e., it is a device capable of connecting one or more home networks 10 with the shared network 20. The photo-sharing device 200 includes a housing 202 (e.g., a body) constructed by one or more portions, for example, the housing 202 may include a top, bottom, front, back, right, and left portions. The housing 202 protects components, such as electrical components, housed by the photo-sharing device 200. In some examples, the housing 202 includes a power a power supply (not shown) that provides power to the photo-sharing device 200. Moreover, the photo-sharing device 200 includes one or more input/output ports such as, but not limited to, HDMI, USB, Bluetooth, Ethernet, wireless Ethernet, where any one of the ports may be used to communicate with a user device 300 or a display system 330. Moreover, the photo-sharing device 200 may include one or more media card receivers (e.g., microSD card slot and/or SD(HX/XC) card slot) supported by the housing 202 and in communication with the photo-sharing device 200. The media card receiver is configured to receive a media card for storing photos 322 and/or videos 324 from the photo-sharing device 200 to the media card or vice versa. Additionally, the photo-sharing device 200 may include an audio device 208 supported by the housing 202. The audio device 208 emits a human perceptible sound indicating storage of the identified photo 322 and/or video 324 on the non-transitory memory 220 of the photo-sharing device 200.

The photo-sharing device 200 includes a processor 210 (e.g., remote computing device or data processing hardware) in communication with non-transitory memory 220. The non-transitory memory 220 may be physical devices used to store programs (e.g., sequences of instructions) or data (e.g., program state information) on a temporary or permanent basis for use by a computing device 210. The non-transitory memory 220 may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

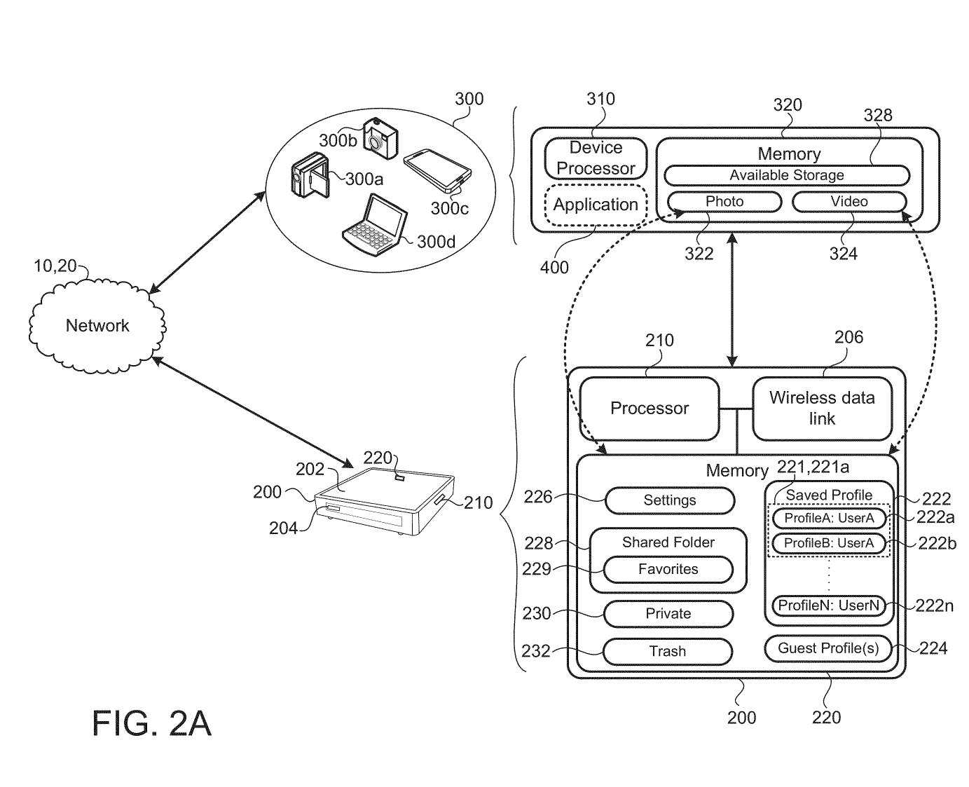

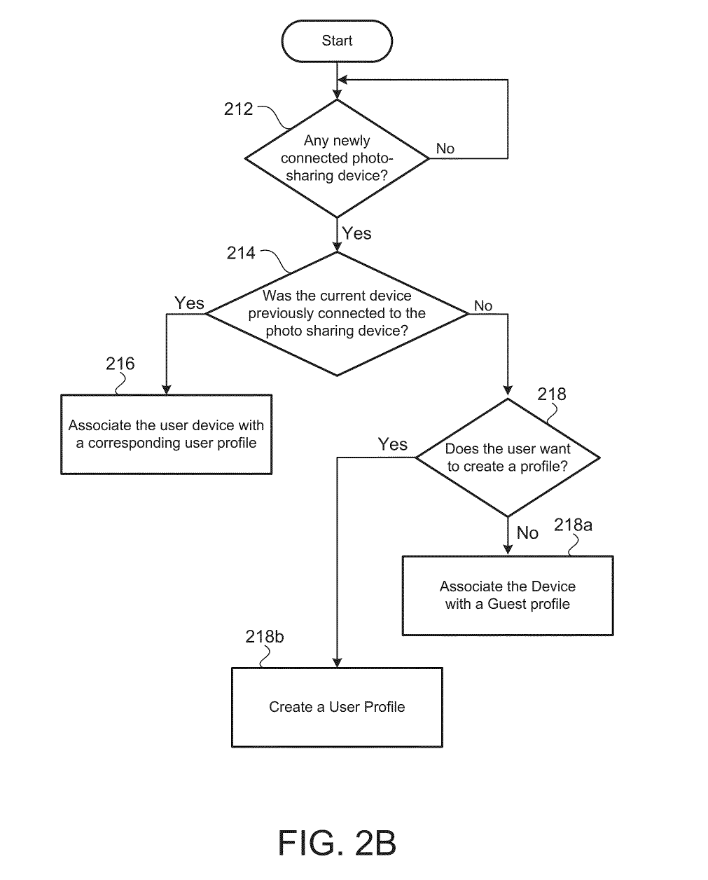

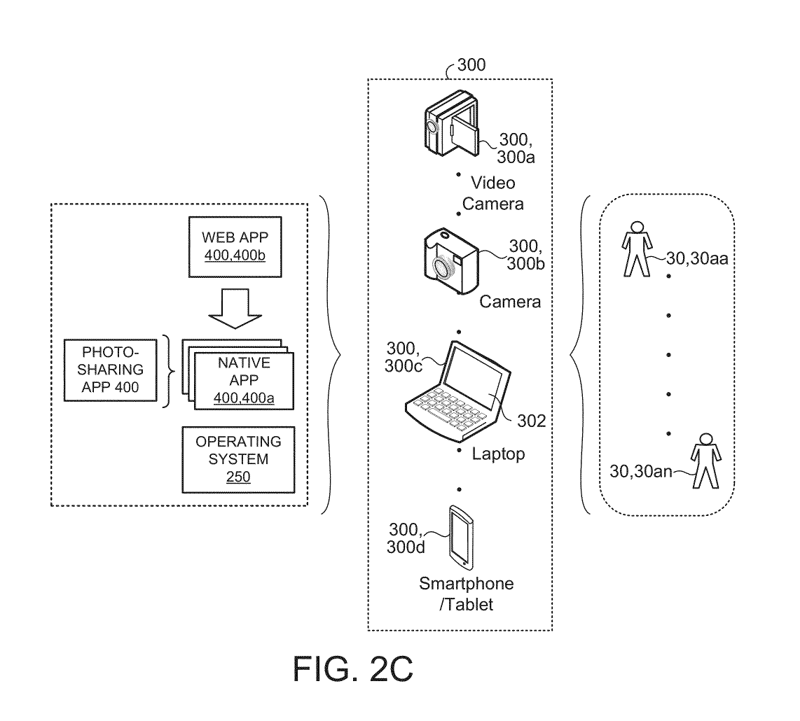

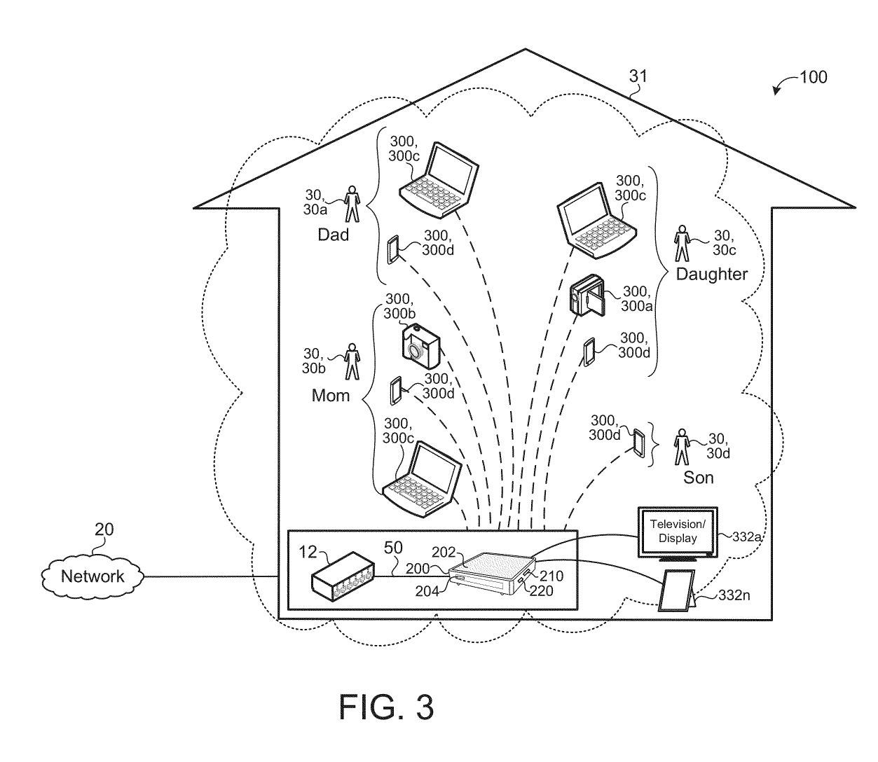

Referring to FIG. 2A-3, in some implementations, the photo-sharing device 200 includes a wireless data link 206 that allows for communication between the network 20 and the user devices 300 and/or between multiple user devices 300 of the household or group 32 (allowing the users 30 to share pictures/videos). The wireless data link 206 communicates with the processor 210 of the photo-sharing device 200. In some examples, the photo-sharing device 200 (e.g., the processor 210) continually queries the home network 10 (e.g., the router 12) to detect a user device 300 connected or has recently connected to the home network 10. In other examples, the photo-sharing device 200 (e.g., the processor 210) continuously or intermittently sends out a signal (e.g., Bluetooth beacon) allowing it to connect with other devices (e.g., a user device).

In some examples, when the processor 210 retrieves the photos 322 and/or videos 324 from the one or more user devices 300, the processor 210 may maintain the source of the photos 322 and/or videos 324, i.e., from which user device 300 the photo-sharing device 200 retrieved the photos 322 and/or videos 324. The user 30 may reorganize the photos 322 and/or videos 324 and place the photos 322 and/or videos 324 in different shared folders 228, or may adjust the photos 322 and/or videos 324 based on tags, labels, collections, albums, or any other organizing method.

In some examples, the photo-device 200 includes one or more indicators 204 that are visible to users 30. The indicators 204 provide an indication of a status of the photo-sharing device 200. The indicators may be LED indicators, or may include a display that displays the status of the photo-sharing device 200. For example, a different indicator 204 may be shown when the photo-sharing device 200 is searching for a user device 300 or when the photo-sharing device 200 is uploading or downloading photos 322 and/or videos 324 to or from a user device 300 or another photo-sharing device 200 locations within a different home network 10 than the current photo-sharing device 200.

In some examples, the photo-sharing device 200 receives photos 322 and/or videos 324 from a user device 300 or from another photo-sharing device 200, where each photo-sharing device 200 is part of a different home network 10. For example, referring to FIG. 1A, the first photo-sharing device 200a may send photos 322 and/or videos 324 to a second photo-sharing device 200b, or vice versa. Each photo-sharing device 200a, 200b being in a different home network 10a, 10b, where the home networks 10a, 10b communicate via the shared network 20. The second photo-sharing device 200b receives the photos 322 and/or videos 324 from the first photo-sharing device 200a and stores the received photos 322 and/or videos 324 in a shared folder 228 of the memory 220 of the second photo-sharing device 200b. Similarly, if the second photo-sharing device 200b is sending or sharing photos 322 and/or videos 324 with the first photo-sharing device 200a, then the first photo-sharing device 200a receives the photos 322 and/or videos 324 from the second photo-sharing device 200b and stores the received photos 322 and/or videos 324 in a shared folder 228 of the memory 220 of the first photo-sharing device 200.

Referring to FIGS. 1A-2C, in some implementations, the user device 300 is associated with a user 30 and is in communication with a remote system 110 via a network 20. The cloud computing resources 110 may be a distributed system (e.g., cloud environment) having scalable/elastic computing resources 114 and/or storage resources 114. The user device 300 and/or the remote system 110 may execute a photo-sharing application 400 and optionally receive photos 322 and videos 324 from one or more photo-sharing devices 200 or user devices 300.

The user device(s) 300 may be any computing device capable of capturing or storing photos 322 and/or videos 324 and transferring or uploading the photos 322 and/or videos 324 to the photo-sharing device 200. User devices 300 include, but are not limited to, mobile computing devices, such as video cameras 300a, photo cameras 300b, laptops 300c, smart phones or tablets 300d, wearable computing devices (e.g., headsets and/or watches). User devices 300 may also include other computing devices having other form factors, such as computing devices included in desktop computers, vehicles, gaming devices, televisions, or other appliances (e.g., networked home automation devices and home appliances).

The user devices 300 may use a variety of different operating systems 250. In examples where a user device 300 is a mobile device, the user device 300 may run an operating system including, but not limited to, ANDROID® developed by Google Inc., IOS® developed by Apple Inc., or WINDOWS PHONE® developed by Microsoft Corporation. Accordingly, the operating system 250 running on the user device 300 may include, but is not limited to, one of ANDROID®, IOS®, or WINDOWS PHONE®. In an example where a user device 300 is a laptop or desktop computing device 300c, the user device 300 may run an operating system including, but not limited to, MICROSOFT WINDOWS® by Microsoft Corporation, MAC OS® by Apple, Inc., or Linux. User devices 300 may also access the photo-sharing application 400 while running operating systems 250 other than those operating systems 250 described above, whether presently available or developed in the future.

Referring to FIG. 2B, a photo-sharing application 400, executing on a user device 300, determines, at block 212, if a photo-sharing device 200 is located near or within a proximity of the user device 300. For example, the photo-sharing application 400 determines if the photo-sharing device 200 is connected to the home network 10, or is within a threshold distance from the user device 300 (e.g., using Bluetooth, near field communication (NFC), or any other method). If the application 400 fails to detect a photo-sharing device 200, the application 400 monitors the network to identify if a photo-sharing device 200 is connected. When the application 400 determines that the photo-sharing device 200 is connected to the home network 10 or is within a threshold distance from the user device 300, then, at block 214, the application 400 determines if the detected user device 300 is associated with a stored profile 222 (stored on the photo-sharing device 200) of a previously detected user device 300. If the application 400 determines that the newly connected user device 300 was previously connected to the photo-sharing device 200 and the photo-sharing device 200 created a user device profile 222 for the user device 300, then application 400 associates the previously created user device profile 222 (stored on the photo-sharing device 200) with the user device 300, at block 216. If however, the application 400 determines that the user device 300 was not previously connected to the photo-sharing device 200, then the application 400 asks the user 30, at block 218, if the user 30 wants to create a user device profile 222. If the user 30 does not want to create a user device profile 222, then the application 400, at block 218a, associates a guest device profile 224 with the connected user device 300. If however, the user 30 wants to create a user device profile 222, then the application 400, at block 218b, creates a user device profile 222 associate with connected user device 300. In some examples, multiple user device profiles 222 and multiple guest device profiles 224 are stored in non-transitory memory 220 of the photo-sharing device 200.

In some implementations, photo-sharing device 200 includes one or more user adjustable settings 226 that the user 30 may adjust via the application 400. The user adjustable settings 226 may be adjusted by a user 30, and stored in non-transitory memory 220. The user adjustable settings 226 may include settings such as: frequency of upload/retrieval, automatic upload/retrieval on/off, upload location (private or shared) and when private any other user device profile that may view the photos 322 and/or videos 324 stored in the private folder 230 associated with a user device 300, device folder(s) for upload/retrieval (a user 30 may organize his/her folders on their user devices 300 and may indicate specific folders 452, 456 on the user device for uploading).

The photo-sharing device 200 may include a trash folder 232 for storing any deleted pictures from the share folder 228. The trash folder 232 provides an additional security layer to any authorized users to delete photos 322 and/or videos 324, from the photo-sharing device 200. Therefore, any deleted photos 322 and/or videos 324 are stored in the trash folder 232, and only deleted from the trash folder 232 when a user 30 provide a pin (e.g., a 4 digit pin or an alphanumeric password) to view and empty the trash folder 232. In some implementations, the application 400 (e.g., display module 444) accesses the trash folder 232 of the photo-sharing device 200 and prompts the user 30 if the user wants to empty the trash folder 232. In some examples, the user 30 may enter a pin or alphanumeric password via the user display 302.

In some implementations, the user device profile 222 includes a main user device profile 222a associated with a user 30 or any specific user device 300 associated with a user 30. The main user device profile to 222a allows the user 30 associated with it to control permissions and settings 226 of the other profiles 222, 224 via the application 400. For example, the main user device profile 222a determines the user device profiles 222 and guest device profiles 224 associated with a user 30 that are allowed to delete photos 322 and/or videos 324 from the shared folder 228. In some instances, the user 30 associated with the main user device profile 222a determines which user device profiles 222 or if a guest device profile 224 can edit or mark as favorite 229 a photo and/or a video 324. Moreover, the main user device profile 222a may determine whether a user device profile 222 or a guest device profile 224 are allowed to upload pictures from the memory 220 of the photo-sharing device 200 to a user device 300 associated with the profile 222, 224. In some examples, the main profile 222a selects via the application 400 specific settings for each user device profile 222 or guest device profile 224, while in other examples, the main user device profile 222a selects settings that are applicable to all the users 30.

In some examples, the main user 222a sets a password or pin that protects some features of the photo-sharing device 200. For examples, if a family of four share their photos and/or videos using the photo-sharing device 200, the parents may be associated with the main profile 222a (i.e., more than one main user device profile may be available) and the children may be associated with user device profiles 222 (not being the main profile). The family member associated with the main user 30 selects the level of access the children in the family are allowed. The user 30 associated with main user device profile 222a may determine that the profile associated with the children is only allowed to upload photos 322 and videos 324 to the photo-sharing device 200; however, the main user 30a may determine that the children are not allowed to download photos 322 and videos 324 to their user devices 300 from the photo-sharing device 200. In some examples, a user 30 who has a device 300 that is associated with a guest device profile 224 and connected to the home network 10 or is within the threshold distance of the photo-sharing device 200, may enter the password or pin to change his/her profile from the guest device profile 224 to a user device profile 222. Once the guest user 30 is associated with the user device profile 222, the guest user 30 may access the photo-sharing device 200 when the user device 300 is not within the home network 10 or within a threshold distance of the photo-sharing device 200. In addition, the main user device profile 222a may remove or take away the user device profile 222 associated with the guest user 30. In such a case, the device 300 of the guest user 30 reverts back to being associated with a guest device profile 224.

The non-transitory memory 220 may include a favorite folder 229 associated with each user device 300. Therefore, the photo-sharing device 200 may keep track of the photos 322 and/or videos 324 marked as favorite by each user 30. In some examples, the processor 210 displays an indicator (e.g., a star) on the display 302, 332 when a photo 322 and/or a video 324 is marked as a favorite. In some examples, a different indicator is associated with different users 30, therefore, two users 30 marked the same photo 322 and/or a video 324 as a favorite, then the processor display on the display 302, 332 two indicators (e.g., two stars each being a different color). Thus a user 30 can view photos 322 and/or videos 324 based on the number of users 30 who marked the photo 322 and/or a video 324 as a favorite.

Referring to FIGS. 2A and 3, in some implementations, first, second, third, and fourth users 30a, 30b, 30c. 30d of a first group 32a (e.g., the Jones family) live in a house 31, while other users 30n are of a second group 32b (FIG. 1A), which may live elsewhere. The first user 30a (e.g., dad) has a laptop 300c and a smartphone 300d; the second user 30b (e.g., mom) has a digital camera 300b, a smartphone/tablet 300d, and a laptop 300c; the third user 30c (e.g., daughter) has a laptop 300c, a digital video camera 300a, and a smartphone/tablet 300d; and the fourth user 30d (e.g., son) has a smartphone 300d. In some examples, each individual user 30a, 30b, 30c, 30d uses his/her personal user device 300 to take photos 322 and/or videos 324. The family 32 may want to share all the photos 322 and/or videos 324 from the multiple devices 300 of each user 30a, 30b, 30c, 30d within the family 32, and view the photos 322 and/or videos 324 collectively as a family 32. The photo-sharing device 200 retrieves photos 322 and/or videos 324 from the multiple user devices 300 and stores the retrieved photos 322 and/or videos 324 in the non-transitory memory 220 of the photo-sharing device 200. As previously explained, the photo-sharing device 200 may connect wirelessly or using a cable 50 to the user devices 300. In some examples, the user 30 may set up his/her user device(s) 300 to automatically download or allow the photo-sharing device 200 to automatically retrieve the photos 322 and/or videos 324 to/from the user device 300. Once the photos 322 and/or videos 324 are downloaded/retrieved from the one or more user devices 300, the photo-sharing device 200 stores the photos 322 and/or videos 324 in its non-transitory memory 220, which allows any or all family members 30 to access and manipulate the photos 322 or the videos 324.

In some examples, when the user device 300 is not within the home network 10 or within a threshold distance of the photo-sharing device 200 of the photo-sharing device 200, the user 30 may upload the photos 322 and/or videos 324 to the photo-sharing device 200 via the shared network 20. As previously discussed, in some examples, only users 30 associated with a user device profile 222 (as opposed to a guest device profile 224) have access to the photo-sharing device 200 when the user device 300 is not within the home network 10 or within a threshold distance of the photo-sharing device 200 of the photo-sharing device 200. Other access arrangements are possible as well. Moreover, in some instances, the user 30 may be prompted (via a photo-sharing application 400 configures to allow for interaction between the photo-sharing device 200 and the user 30 via the user display 302 of the user device 300) to determine whether to allow the photo-sharing device 200 to access the non-transitory memory 320 of the user device 300 and delete or keep the photo 322 and/or a video 324 after they are uploaded to the non-transitory memory 220 of the photo-sharing device 200.

In some examples, a user 30 may have one or more user devices 300. Therefore, the photo-sharing device 200 may associate a user device profile 222 (or guest device profiles 224) with each user device 300 and associate a user profile 221 with the user 30 of the multiple user devices 300. For example, the photo-sharing device 200 associates three different device user profiles 222a, 222b, 222c with each of the dad's devices, and associates a user profile 221a with the dad 30a that links all the devices 222a, 222b, 222c to the dad profile 221a. Moreover, the dad 30a may have some personal photos/videos that he does not want to share with the family 32 or wants to select which members of the family 32 to share these photos 322 and/or videos 324 with. The photo-sharing device 200 allows the dad 30a to store the private photos in a private folder 230 of the memory 220, allowing only the dad 30a and any other person that the dad 30a gives permission to view the photos 322 and/or videos 324.

In some examples, the main user device profile 222a associated with a main user 30 (e.g., dad 30a or mom 30b) determines which user device profiles 222 (or guest device profiles 224) can delete, edit, upload or download photos 322 and/or videos 324. Additionally, when a user 30 deletes a photo 322 and/or a video 324, the photo-sharing device 200 moves the deleted photo 322 and/or a video 324 from the shared folder 228 to the trash folder 232 (which may need a pin or password to delete the photos 322 and/or videos 324).

The photo-sharing device 200 may be connected to a network box 12 (i.e., a router or a gateway router) through a wired connection 50 (e.g., cable), such as a coaxial interface, an RJ-45 interface, and/or a wireless interface, such as an RG-45 Ethernet interface for 802.11 Wi-Fi. A Wi-Fi connection may be slower than a wired connection; therefore, a user 30 may determine which devices 300 he/she wants to connect wirelessly verses the devices 300 he/she wants to connect via a wired connection (e.g., cable 50). Such determination depends on the desired speed that the user 30 wants the device 300 to communicate with other devices 300 or the networks 10, 20. In some examples, the network box 12 includes Ethernet ports for connecting the electronic devices 300 to the network box 12 using an Ethernet cable. The network box 12 may have a predetermined number of output ports (e.g., four output ports) that support a wired connection (e.g., cable 50). A user 30 may need more than four output ports to connect his/her devices 300 and may connect a network device 12, 300 capable of expanding the network 10 (expanding the wired network 10).

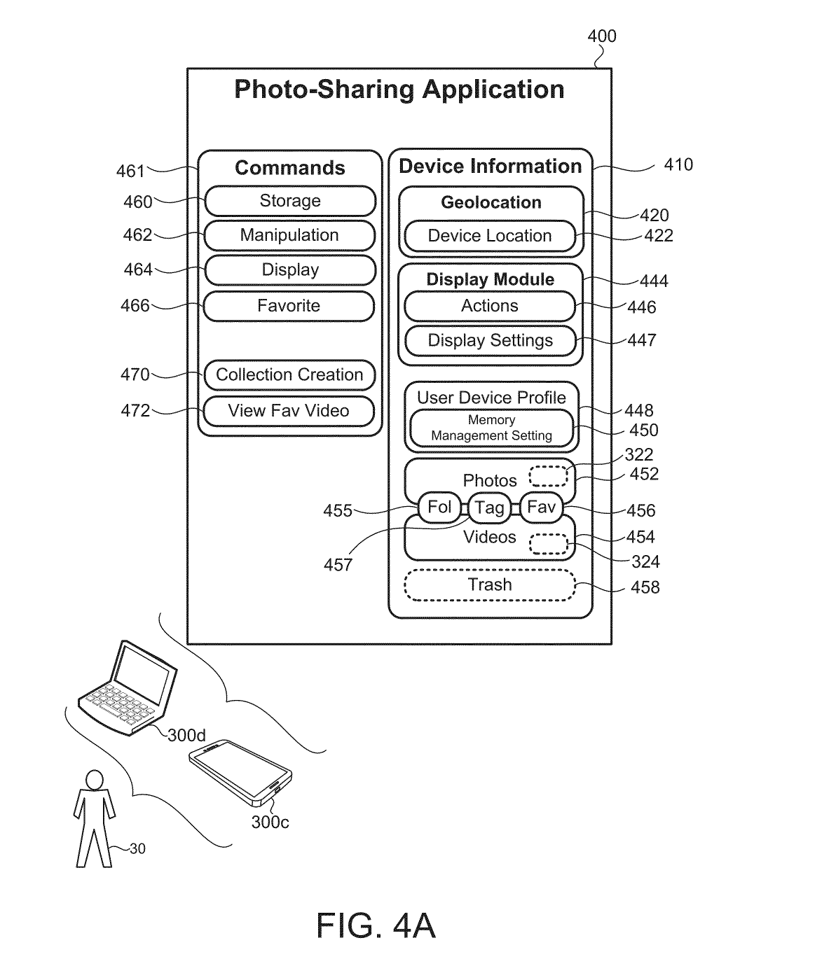

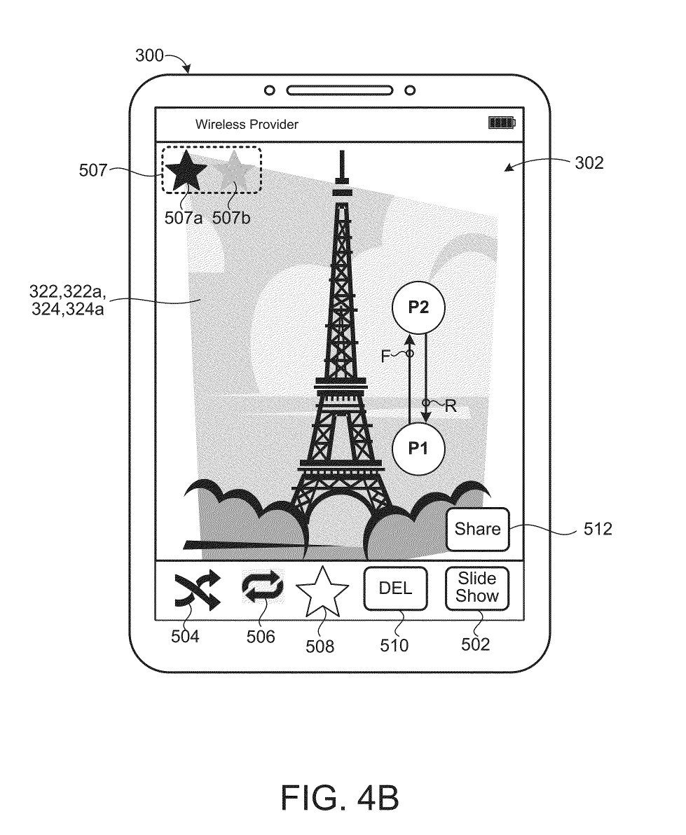

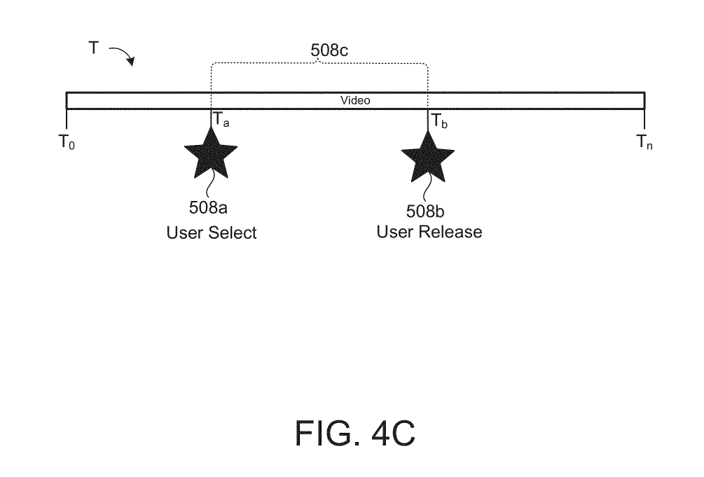

In some implementations, the user device 300 includes a device processor 310 in communication with a device non-transitory memory 320. The user device 300 is capable of transmitting photos 322 and/or videos 324 from the device non-transitory memory 320 to the memory 220 of the photo-sharing device. The device processor 310 executes a photo-sharing application 400 that allows the user 30 to download/upload and optionally edit photos 322 and/or videos 324 stored on the non-transitory memory 220 of the photo-sharing device 200. The photo-sharing application 400 retrieves device information 410 (See FIG. 4) from the user device 300 and transmits the information to the photo-sharing device 200. In some examples, the device non-transitory memory 320 includes a photo folder 452 (FIG. 4) for storing photos 322 and a videos folder 454 (FIG. 4) for storing video 324. The user 30 may add or rename folders to organize photos 322 and/or videos 324 in the device memory 320. Moreover, a user 30 may determine which folders to share with the photo-sharing device 200.

The photo-sharing application 400 allows the user 30 to download/upload photos and/or videos from or to the photo-sharing device 200 within a home network 10 that is connected to the user device 300 executing the photo-sharing application 400. In addition, the photo-sharing application 400 allows a user device 300 connected to a first home network 10a that is also connected to a first photo-sharing device 200a to connect to a second photo-sharing device 200b connected to a second home network 10b, where the first home network 10a and the second home network are connected via a shared network 20.

Referring back to FIG. 2C, a software application 400 may refer to computer software that, when executed by a computing device, causes the computing device to perform a task. In some examples, a software application 400 may be referred to as an “application”, an “app”, or a “program”. Example software applications 400 include, but are not limited to, word processing applications, spreadsheet applications, messaging applications, media streaming applications, social networking applications, and games.

Applications 400 can be executed on a variety of different user devices 300. In some examples, a native application 400a may be installed on a user device 300 prior to a user 30 purchasing the user device 300. In other examples, the user may 30 download and install native applications 400a on the user device 300.

The functionality of an application 400 may be accessed on the computing device 300 on which the application 400 is installed. Additionally or alternatively, the functionality of an application 400 may be accessed via a remote computing device 112. In some examples, all of an application's functionality is included on the computing device 112, 300 on which the application 400 is installed. These applications 400 may function without communication with other computing devices 112, 310 (e.g., via the shared network 20, e.g., Internet). In other examples, an application 400 installed on a user device 300 may access information from other remote devices 300 during operation. In still other examples, a web-based application 400b (also referred to herein as a web application) may be partially executed by the user device 300 and partially executed by a remote computing device 112. For example, a web application 400b may be an application 400 that is executed, at least in part, by a web server and accessed by a web browser (e.g., a native application 400a) of the user device 300. Example web applications 400b may include, but are not limited to, web-based email, online auctions, and online retail sites.

In general, the user device 300 may communicate with photo-sharing device 200 using any software application 400 that can send and receive photos 322 and/or videos 324 and that is capable of interfacing with the photo-sharing device 200, such as a native application 400a dedicated to sharing and editing photos.

In some examples, the user device 300 communicates with the photo-sharing device 200 using a more general application 400, such as a web-browser application 400b accessed using a web browser native application 400a. Although the user device 300 may communicate with the photo-sharing device 200 using the native photo-sharing application 400a and/or a web-browser application 400b, the user device 300 may be described hereinafter as using the native photo-sharing application 400 to communicate with the photo-sharing device 200. In some implementations, the functionality attributed to the photo-sharing application 400 may be included as a photo-sharing component of a larger application 400 that has additional functionality. For example, the functionality attributed to the photo-sharing application 400 may be included as part of a native application 400a or a web application 400b as a feature that provides photo-sharing features and capabilities.

Native applications 400a can perform a variety of different functions for a user 30. For example, a restaurant reservation application can make reservations for restaurants. As another example, an internet media player application can stream media (e.g., a song or movie) from the Internet. In some examples, a single native application 400a can perform more than one function. For example, a restaurant reservation application may also allow a user to retrieve information about a restaurant and read user reviews for the restaurant in addition to making reservations. As another example, an internet media player application may also allow a user to perform searches for digital media, purchase digital media, and generate media playlists.

Referring to FIG. 4, in some implementation, the photo-sharing application 400 retrieves device information 410 from the user device 300 and transmits the device information 410 to the photo-sharing device 200. Some application modules of the photo-sharing application 400 used to capture the device information 410 may include, but are not limited to, a geolocation service module 420 that acquires a user device location 422 (e.g., from a geolocation device of the user device 300), a user display module 444 that acquires user actions 446 performed by the user 30 on a user device display 302 or a remote display 332 (e.g., to manipulate a photo) and/or display settings 447. The device information 410 may also include a user device profile 448 (that includes settings such as, but not limited to, device memory management 450), one or more photos folder 452 having photo content 322 to be uploaded to the photo-sharing device 200, one or more videos folder 454 having video content 324 to be uploaded to the photo-sharing device 200, and optionally a device trash folder 458 having photo and/or video content 322, 324 for deletion by the photo-sharing device 200 (e.g., from the user device memory 320 and/or the memory 220 of the photo-sharing device 200).

Geolocation services 402 identify a geographic location of an object (e.g., user device 300). Geolocation services 402 use a global positioning system (GPS) to determine a specific device location 402a, such as, a street intersection or an address rather than a set of geographic coordinates. Internet and computer geolocation may be performed by associating a geographic location with the internet protocol address, machine access control (MAC) address, radio frequency identifier (RFID), hardware embedded article or production number, embedded software number, Wi-Fi positioning system, device GPS coordinates, or other information.

In some examples, the geolocation services 402 include a location-based service (LBS), which is an information service for providing specific controls for location and time data. LBS is generally used in social networking and as entertainment services. LBS includes services for identifying a location of a person or an object. Some examples include locating a friend, a family member or an employee or locating the nearest restaurant, park, or hotel. In some examples, LBS is used for mobile commerce and for targeting users in a specific location with advertisements and coupons of businesses in the user's vicinity based on the user's location. LBS services may include personalized weather services and news services.

In some implementations, the photo-sharing application 400 communicates with the photo-sharing device 200 via the home network 10 or the shared network 20 and sends the photo-sharing device 200 the device location 422. In some examples, based on the device location 422, the photo-sharing device 200 initiates retrieval of photos 322 and/or videos 324 from the user device storage 320. The user 30 of the device 300 that executes the photo-sharing application 400 may select which folders 455 stored on the device storage 320 may be accessed by the photo-sharing device 200 so that the photo-sharing device uploads the photos 322 and/or videos 324 in the specified folder to the photo-sharing device 200 (e.g., on non-transitory memory 220). Moreover, when a user 30 captures a photo 322 and/or a video 324, the photo-sharing application 400 associates a current device location 422 with the photo 322 and/or a video 324.

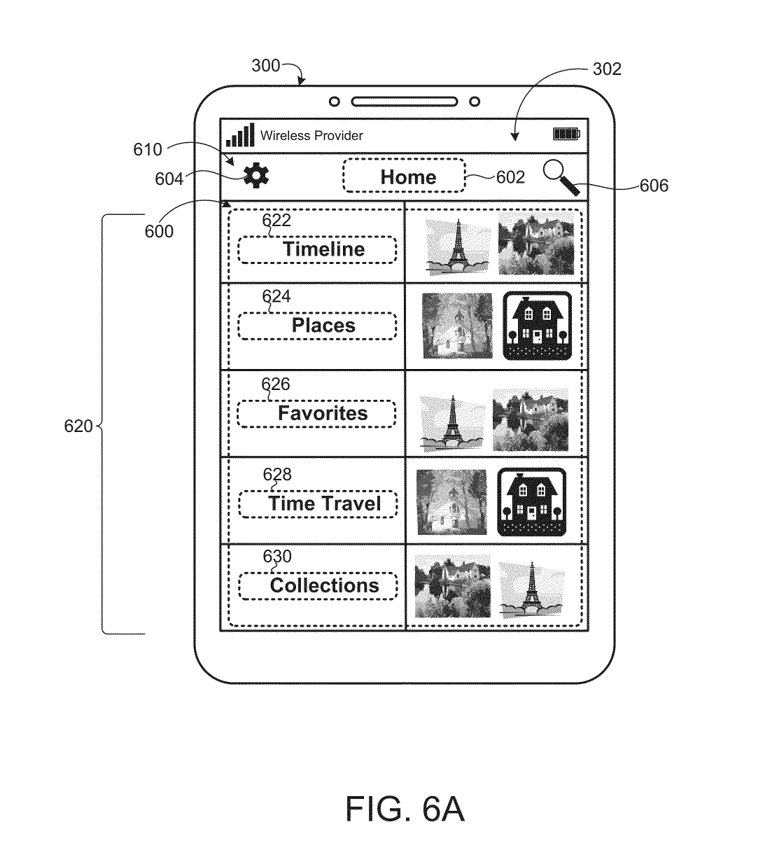

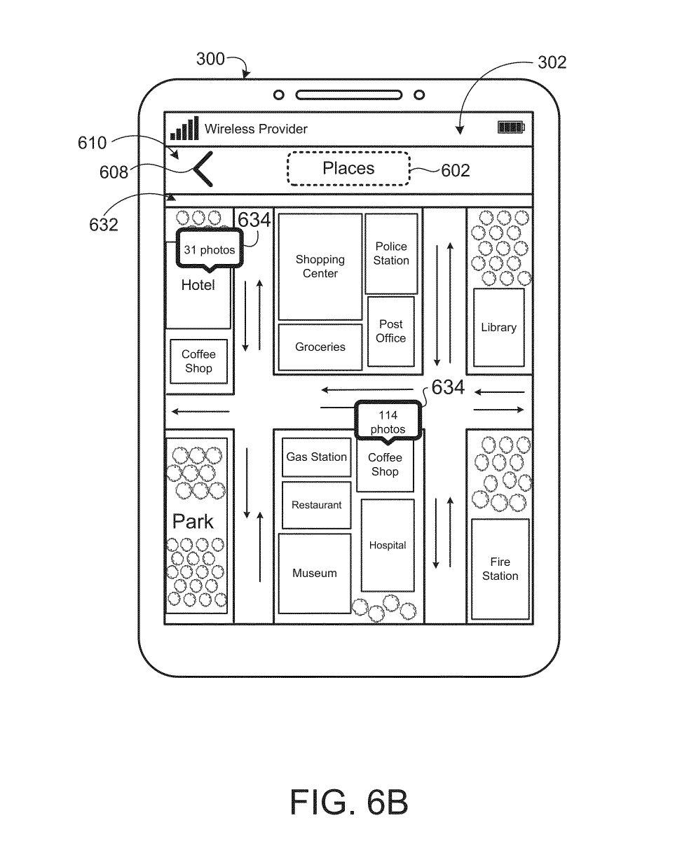

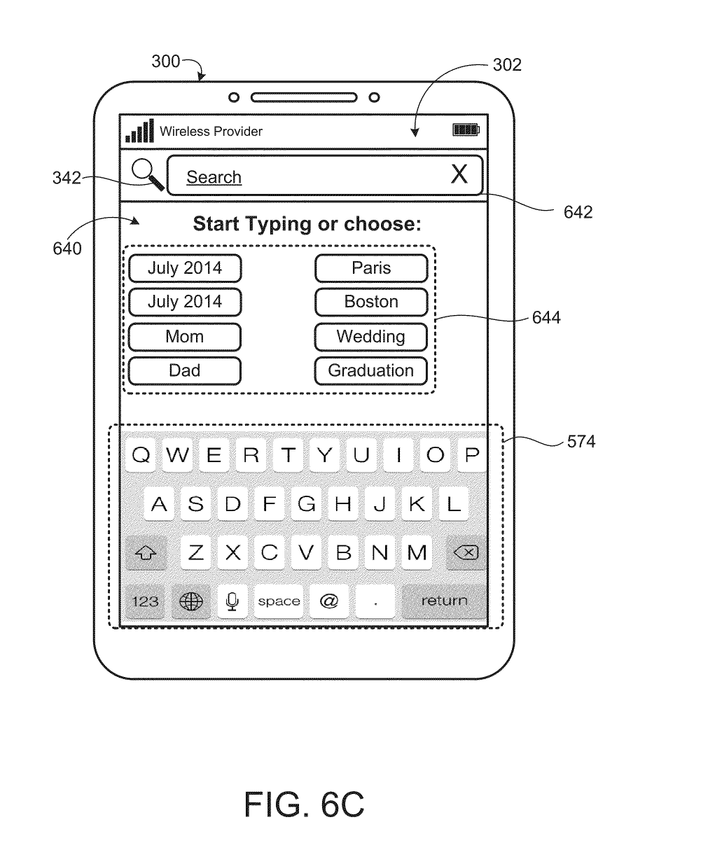

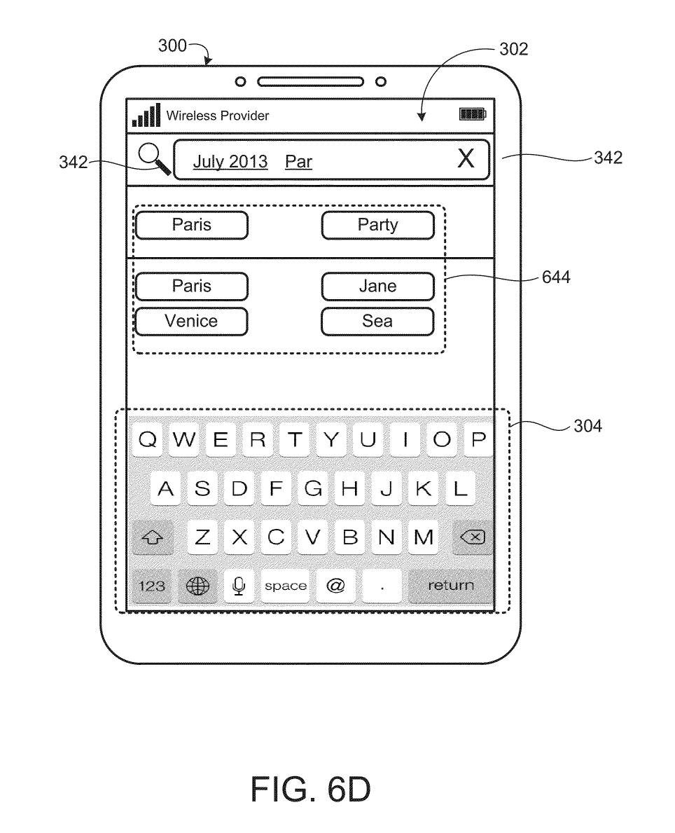

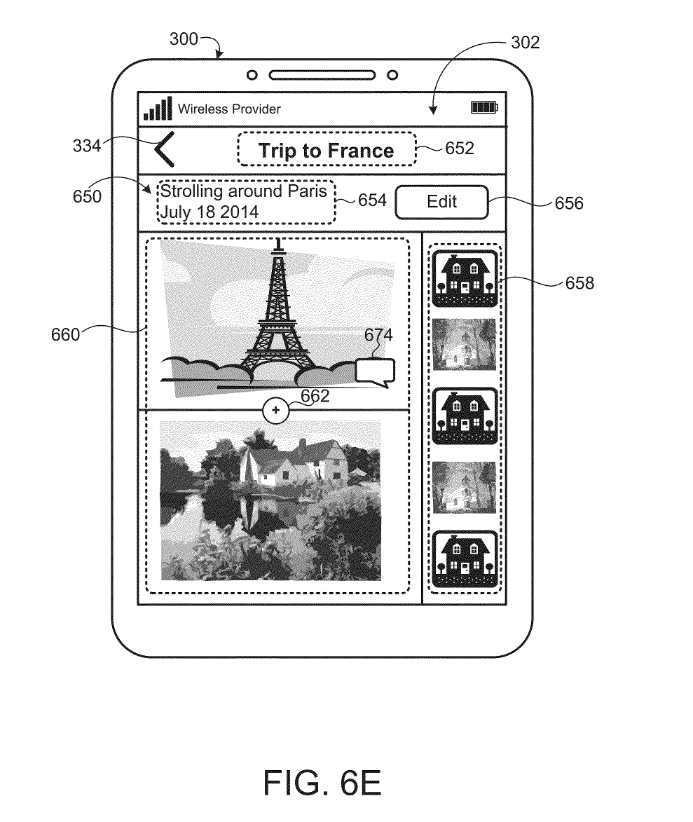

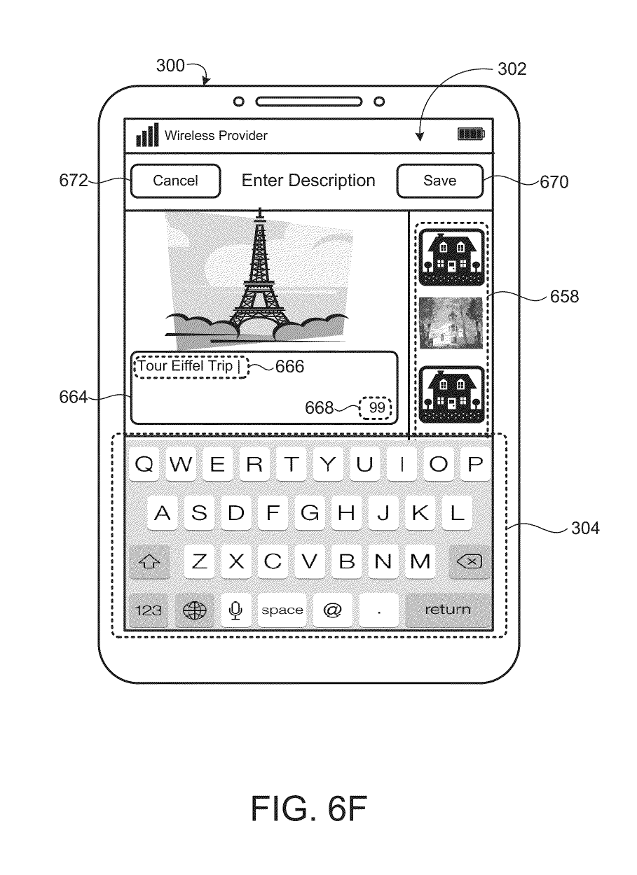

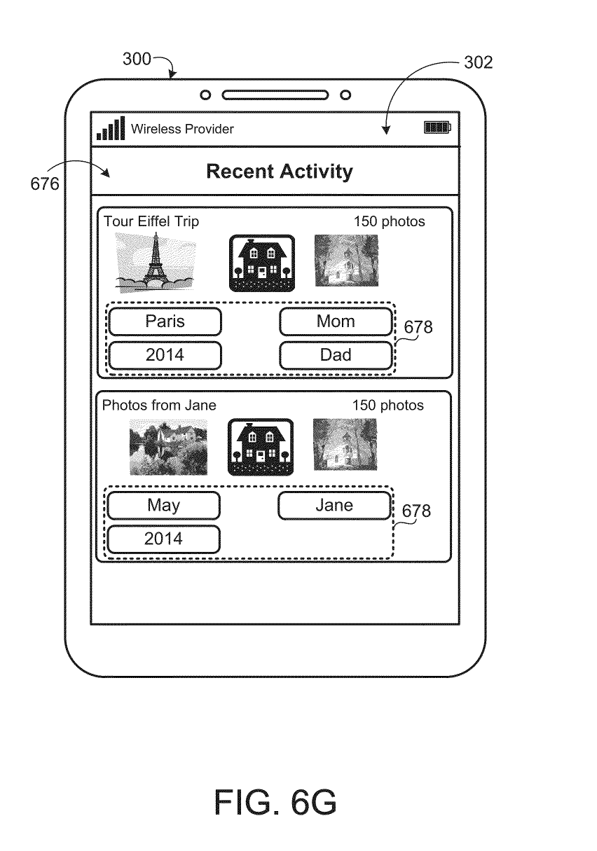

The photo-sharing application 400 includes a display module 444 configured to control the display of photos 322 and/or videos 324 stored in the non-transitory memory 220 of the photo-sharing device 200 on the display 332. Therefore, the display module 444 controls photos 322 and/or videos 324 stored on the photo-sharing device 200, not on the user device 300. Any changes made to the photo 322 and/or video 324 are made to the version of the photo 322 and/or a video 324 stored on the photo-sharing device 200. The display module 444 includes actions 446, such as, but not limited to, displaying photos 322 and/or videos 324 on the display 332, cropping a photo 322, adding an audio note (using the audio icon 674 FIG. 6E) to a photo 322 (or a video 324), associating a previously recorded voice recording with a photo 322 and/or a video 324 (e.g., associating a song with the photo 322 or video 324), rotating a photo 322, combining photos into a collage, selecting a photo 322 and/or a video 324 as a favorite. Other photo 322 and/or a video 324 edits are possible as well.

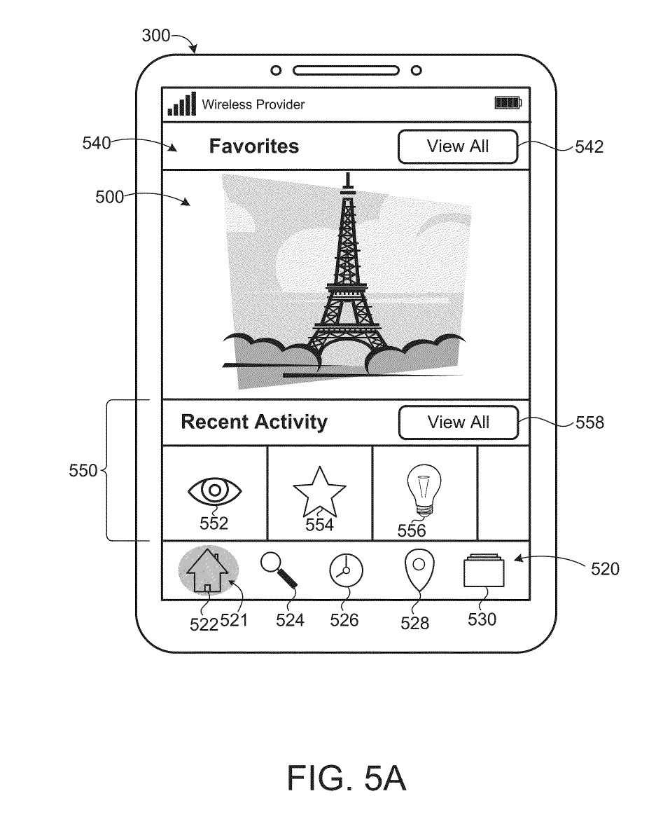

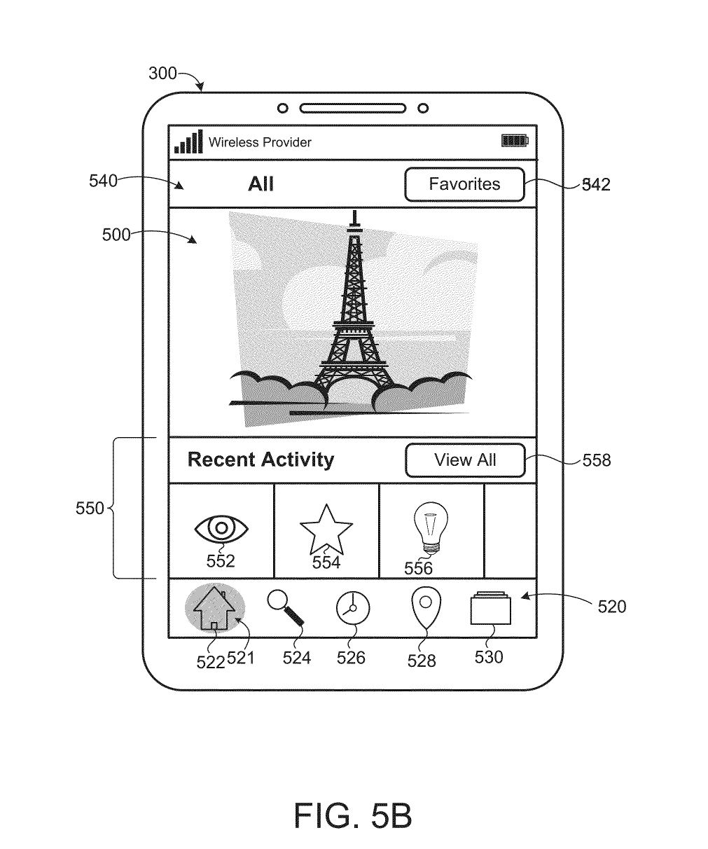

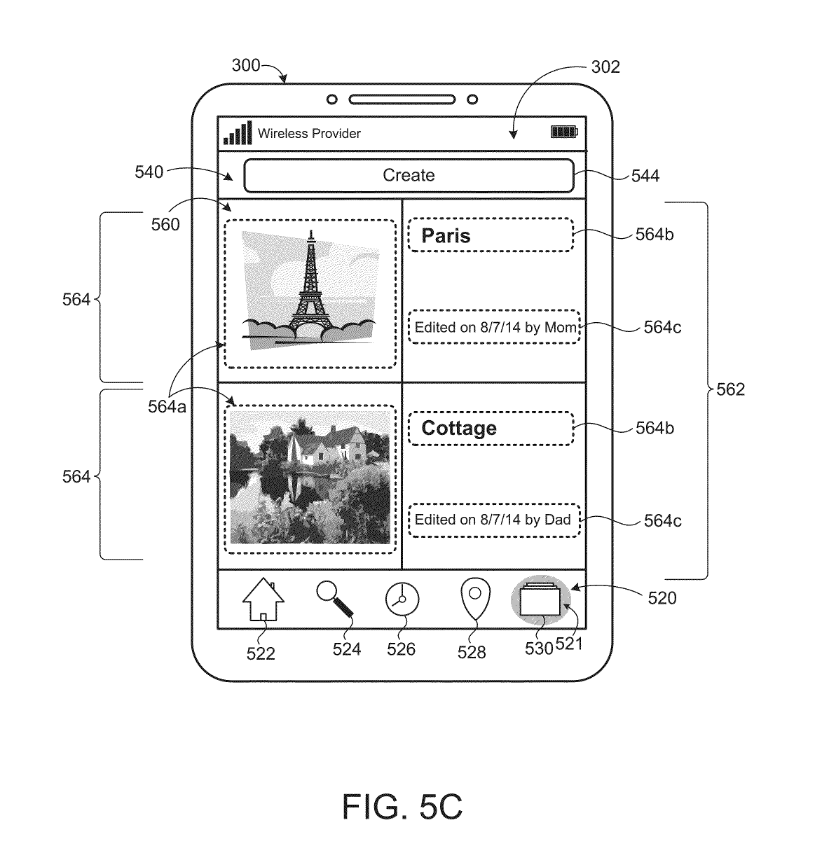

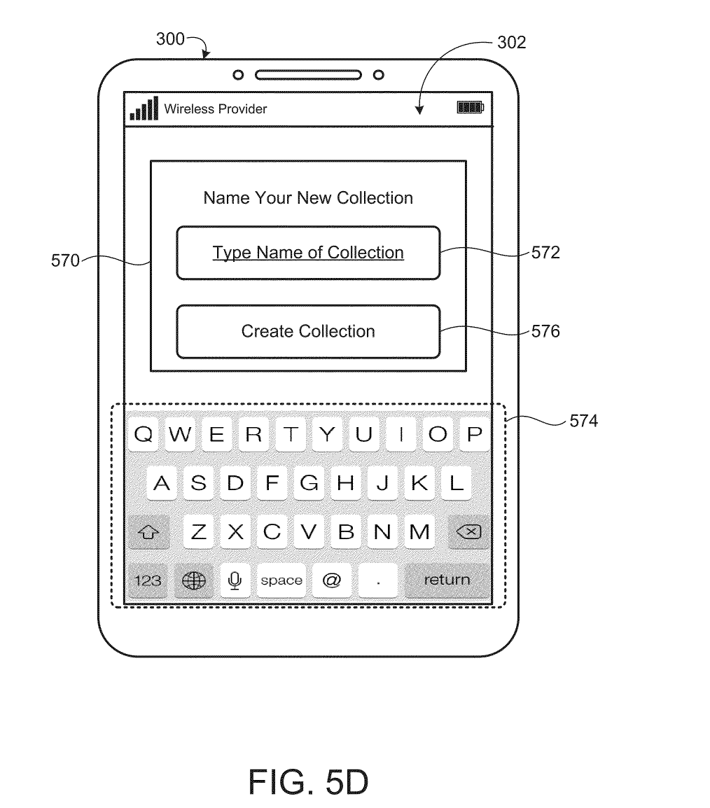

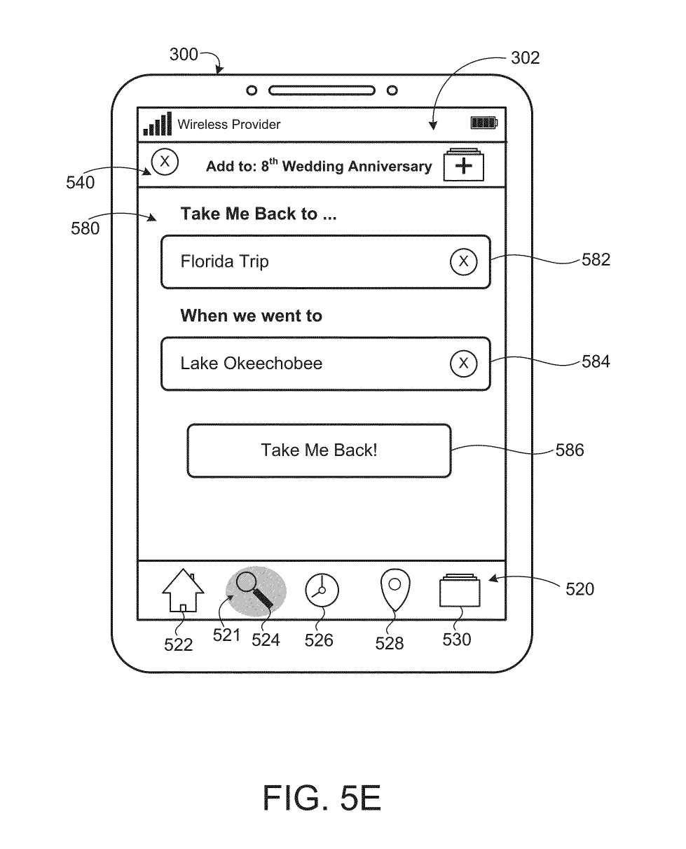

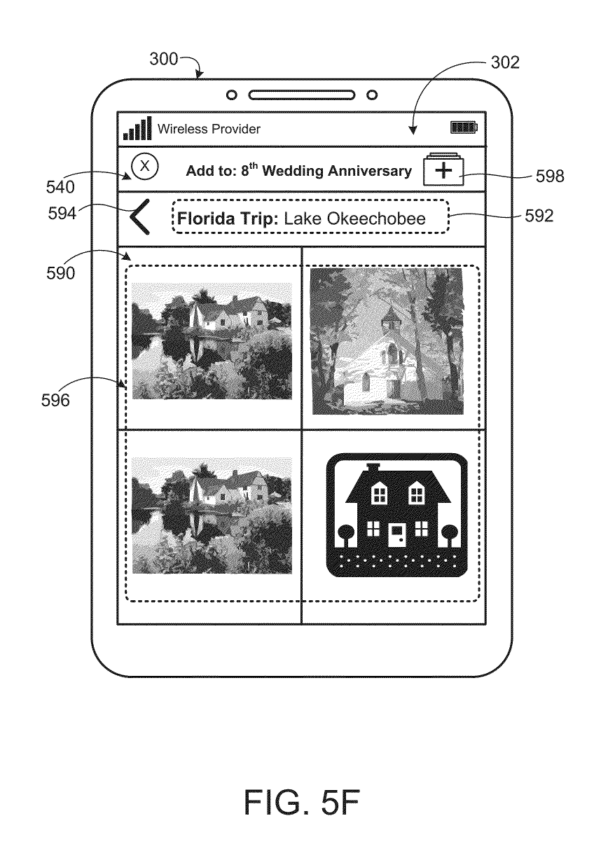

In some implementations, the display module 444 displays on a display 302 of the user device 300 a control buttons (FIG. 5A-7) that allow the user 30 to control the photos 322 and/or videos 324 stored on the non-transitory memory 220 of the photo-sharing device 200. The controller allows the user 30 to select actions 446 to be performed by the photo-sharing device 200.

In some examples, the photo-sharing device 200 is connected to the display 332. When the user device 300 is not connected to the photo-sharing device 200, the photo-sharing device 200 may be in an auto-display-mode and displays on the display 332 a selection of photos 322 stored on the non-transitory memory 220 of the photo-sharing device 200. In some examples, a user 30 may adjust the display settings 447 of the photo-sharing device 200 when the photo-sharing device 200 is in the auto-display-mode displaying images on the display 332. If the user 30 does not adjust the display settings 447 of the photo-sharing device 200, then the photo-sharing device 200 randomly displays photos 322 stored on its non-transitory memory 220. However, the user 30 may adjust the display settings 447 of the photo-sharing device 200, and the photo-sharing device 200 may display images in a selected-display mode. For example, the display settings 447 may include, but not limited to, allowing a user 30 to display photos 322 associated with a specific folder, a specific tag, favorites, a year, a timeframe, or a combination thereof.

In some implementation, the user 30 decides to override the photos 322 being displayed on the display 332 and wants to display another one or more photos 322 stored on the non-transitory memory 320 of the photo sharing device 200. Therefore, the photo sharing application 400 allows the user 30 to select a photo 322 from the photo-sharing device 200 and view the photo 322 on the display 302 of the user device 300 (where the photo 322 is only stored on the non-transitory memory 220 of the photo-sharing device 200). As shown in FIG. 4B, the selected photo 322a (from the photo-sharing device 200) is displayed on the display 302 of the user device 300. The user 30 may decide to display the selected photo 322a on the display 332. In some examples, the user 30 may place a finger on the device display 302 (e.g., a touch screen) at a first position P1 and slide finger to the second position P2 in a foreword direction F. Such a “forward Flinging” motion or a swinging motion by the user 30 allows the selected photo 322a to be displayed on the display 332. In some examples, if the display 332 is turned off, the forward direction F flinging motion causes the display to turn on and display the selected photo 322a. The forward flinging motion provides a mirrored display, allowing the user 30 to view the selected photo 322a both on the display 332 and the user display 302. Therefore, the user 30 may edit the selected image on the user display 302 and the changes to the selected photo 322a are reflected on the display 332. This is useful when a group 32 of users 30 are viewing one or more photos 322 and want to edit the images as a group 32. Moreover, if the user 30 wants to revert to the auto-display-mode or the selected-display-mode, the user 30 places his finger on the user device display 302 at the second position P2 and slides his/her finger to the first position P1 in a rearward direction R. This rearward flinging motion stops displaying the selected photo 322a on the display 332 and only displays the selected photo 322a on the user device display 302. The photo-sharing device 200 reverts to its auto-display-mode or the selected-display-mode based on the display settings 447 selected by the user 30. Moreover, if the user 30 performance of a flinging motion (e.g., swipe motion on the display 302) from right to left or left to right, then the user device 300 moves the selected photo on the user display 302 off screen (e.g., is no longer visible) and displays the next (right to left) or previous (left to right) photo in the photos folder 452 (e.g., favorites folder 456) on the display 302. Therefore, the user 30 may select one or more photos 322 to view and browse through the selected photos 322a, edit the selected photos 322a, while the display 332 co-displays the interactions and edits that the user 30 is making on the device display 302, thus allowing other users 30 to also view what the user 30 is viewing on his/her user device 300. In some examples, the user 30 may touch a slideshow button 502 on the device display 302. The slideshow button 502 causes the selected photo 322a to automatically move to next photo 322 within photos folder 452 (e.g., favorites folder 456) of the photo 322 being displayed.

In some examples, a user 30 can select a shuffle button 504 displayed on the user device display 302. The shuffle button 504 shuffles the photos within the photo folder 452 being viewed by a user 30. In addition, a user 30 can select a repeat button 506 displayed on the user device display 302. The repeat button 506 repeats the photos 322 within the photo folder 452 being viewed by a user 30 once all the photos 322 have been viewed once.

In some implementations, while viewing the photos 322, a user 30 may select a favorite button 508 for indicating that the selected photo 322 is a favorite of the user 30. In other examples, the user may double tap the display 302 where the photo 322 is being displayed. When a photo 322 is marked as a favorite, the favorite button 508 may change appearance to differentiate the favorite photo from the non-favorite photos 322. When the photo-sharing device 200 is in communication with the user device 300, the photo-sharing device 200 stores the photos 322 viewed and marked as favorite on the memory 220 (e.g., favorite folder 229) of the photo-sharing device 200. However, if the photo-sharing device 200 is not in communication with the user device 300, then the photos 322 viewed, and marked as favorites are stored on the memory 320 of the user device 300.

In some examples, each photo 322 may be associated with an indicator 507 indicative of the number of users 30, who have indicated that the photo 322 and/or a video 324 is one of their favorites (e.g., by way of the favorite button 508). The user 30 may select to view photos 322 and/or videos 324 having the most number of indicators 507, i.e., the photos 322 and/or videos 324 that are associated with the most number of favorites button 508 presses. In some examples, each indicator 507 is associated with a user 30 and the indicators are different than one another, e.g., different shape or color. Therefore, if a first user 30 associated with a first indicator 507a marked that the selected photo 322a is a favorite, and a second user 30 also marked that the selected photo 322a is a favorite, the processor 210 of the photo-sharing device 200 displays the first indicator for processing and the second indicator for submitting the different from one another, indicating that the first user 30a and a second user 30b liked the selected photo 322a.

Referring to FIGS. 4G and 4C, in some implementations, a user 30 may select a video 324 or a portion of a video as a favorite. In some instances, a user 30 may record a video having a duration of T=Tₙ and the user 30 wants to select a portion of the video 324 as a favorite portion 508c. While the user 30 is watching the video 324, the user may press the favorite button 508 at a first time Tₐ and release the favorite button 508 at a second time T_{b}, where T₀≦Tₐ<T_{b}≦Tₙ. When viewing the video 324 after a favorite portion 508a has been selected, the user 30 may view only the selected favorite portion 508c.

Referring back to FIG. 4, the photo-sharing application 400 includes storage 324 configured to store a user device profile 448 (including memory management settings for 50), photos 452, videos 454, favorites 456 (photos 322 and/or videos 324), and optionally a trash folder 458. The user device profile 448 includes any settings specific to the user device 300, such as, but not limited to the frequency that the user device 300 may communicate with the photo-sharing device 200 to allow the upload of the photos 322 and/or videos 324 from the user device 300 to the photo-sharing device 200. In some examples, every time the photo-sharing device 200 detects the user device 300, the photo-sharing device 200 retrieves any new photos 322 and/or videos 324 not previously retrieved. In other examples, the photo-sharing device 200 retrieves new photos 322 and/or videos 324 every specific period of time, for example every Monday at midnight, or every other day at 9 pm, other possible timings are possible as well.

In some implementations, the device user profile 448 includes a memory management setting 450. The memory management setting 450, when enabled by the user 30, automatically manages the memory 320 of the user device 300. For example, a user 30 may be traveling and taking a lot of photos 322. The device memory 220 may get filled and the user 30 has to delete some photos 322 stored on the device memory 320 before being able to take more photos 322. This may be an inconvenience for a user 30, especially when a user 30 takes many photos 322. Therefore, the memory management settings 450 monitors the memory 320 of the user device 300 and stores photos 322 and/or videos 324 that meet a threshold on the photo-sharing device 200 and deletes the stored photos 322 and/or videos 324 from the user device 300 (e.g., memory 320). Therefore, the user 30 always has enough available storage capacity 328 on the user device 300 to take photos 322 and/or videos 324. The threshold may be a date threshold or a size threshold, or any other threshold that filters the photos based on criteria (e.g., size, date, and/or folder).

The user 30 sets and modifies the settings of the user device profile 448 including the memory management settings 450 on the user device 300. If the user 30 makes the modifications when the user device 300 and the photo-sharing device 200 are connected, then the user device profile 448 is stored both on the memory 320 of the user device 300 and on the memory 220 of the photo-sharing device 200. However, if the user 30 makes modifications to the user device profile 448 when the user device 300 and the photo-sharing device 200 are not connected, then the user device profile 222, 448 is stored on the memory 220 of the photo-sharing device 200 and updated when the devices first connect via a home network 10, or in some examples, via a shared network 20.

The photo-sharing application 400 includes a photo folder 452 for storing photos 322 and a video folder 454 for storing videos 324. In some examples, a user 30 selects a photo 322 and/or a video 324 as a favorite photo 322 and/or a video 324 and the photo-sharing application 400 stores the favorite photo 322 and/or a video 324 in a favorite folder 456. In some examples, if a user 30 selects a photo 322 and/or a video 324 stored on the user device 300 as a favorite photo 322 and/or a video 324, the user device 300 uploads the favorite photo 322 and/or a video 324 to the photo-sharing device 200. The photo 322 and/or a video 324 maintain their favorite label and remain in a favorite folder 229 on the photo-sharing device 200.

In some implementations, the photo sharing application 400 includes a trash folder 458. The trash folder 458 stores photos/videos marked for deletion by a user 30 (when the user 30 selects the delete button 510 see FIG. 4B). In some examples, a photo 322 and/or a video 324 marked for deletion on the user device 300, may also be stored on the photo-sharing device 200. In such a case, when the user devices connects to the photo-sharing device 200 and the user 30 deletes the photo 322 and/or a video 324 stored on the user device 300, the photo sharing application 400 prompts the user 30 to indicate whether he/she wants to delete the photo 322 and/or a video 324 from the photo-sharing device 200 as well. If, however, the user device 300 is not connected to the photo-sharing device 200, then the application 400 stores the photo 322 and/or a video 324 marked for deletion in the trash folder 458 until the user device 300 is in communication with the photo-sharing device 200. Upon connection of the user device 300 with the photo-sharing device 200, the application 400 may prompt the user 30 to indicate whether he/she wants the photos 322 and/or videos 324 marked for deletion on the user device 300 (i.e., in the trash folder 458) to also be deleted from the photo-sharing device 200.

In some implementations, a user may select a share button 512 on the user display 320. When the user 30 selects the share button 512, the application 400 shares the photo 322 or video 324 with other applications, such as, but not limited to, Facebook®, Instagram®, YouTube®, email, text messaging, or any other application configured to allow a user 30 to share a photo 322 or video 324 with one or more users 30. In addition, the user 30 may be able to share the photo(s) 322 and/or video(s) 324 with another user 30 having a different photo-sharing device 200 associated with a different home network 10 than the current photo-sharing device 200 (see e.g., FIG. 1A, a first user 30a in a first group 32a may share photo(s) 322 and/or video(s) 324 with a second user 30b in a second group 32b). In another example, the share button 512 allows the user 30 to upload the photo(s) 322 and/or video(s) 324 to the cloud resources 114.

Referring to FIGS. 5A-5F, in some implementations, the application 400 allows a user 30 to search for specific photos 322 and/or videos 324, albums, collections, or for any other tag associated with photo 322 and/or a video 324. FIG. 5A shows a home screen 500 displayed on a user device 300. The home screen 500 includes a bottom bar 520 showing the current screen icon, the home icon 522 with an indicator 521 indicating that the current screen displayed on the user device 300 is the home screen 500. The bottom bar 520 also includes a search button 524, a history button 526, a location button 528, and a folder button 530. A user 30 may select any of these buttons 522, 524, 526, 528, 530, to change the home screen 500, to a search screen 580, a history screen, a location screen, or a folder screen 560.

The home screen 500 includes a top bar 540 showing the folder that the user 30 is viewing. In some examples, the top bar 540 includes an alternate view button 542, allowing the user 30 to switch between viewing only photos 322 and/or videos 324 marked as a favorite or all the photos 322 and/or videos 324 stored on the photo-sharing device 200. Moreover, in some examples, the user 30 may select to view photos 322 and/or videos 324 marked as favorite by one or more other users 30. For example, as shown in FIG. 5A, the user 30 is viewing the photo 322 or video 324 that are selected as a favorite on the memory 220 of the photo-sharing device 200; while, in FIG. 5B the user 30 is viewing all the photos 322 and/or videos 324 stored on the memory 220 of the photo-sharing device 200.

The home screen 500 also includes a middle bar 550 that includes a recent activities performed by the user 30. For example, as shown in FIG. 5A, the middle bar 550 includes a recently viewed button 552, a favorite button 554, and a collection button 556. The user 30 may select one of the buttons 552, 554, 556 and a list of the photos 322 and/or videos 324 associated with the features of the button are displayed. For example, the recently viewed button 552 displays photos 322 and/or videos 324 that have been previously displayed within a threshold period of time (e.g., a week, a month, etc.). The favorite button 554 displays the photos 322 and/or videos 324 marked as a favorite and recently viewed. While the collection icon 556 displays the collections that were created or viewed by one or more users 30. Additional activities may be available, and a view all button 558 may be displayed to show the user 30 any other recent activities.

FIG. 5C shows an exemplary folder screen 560 as indicated by the indicator 521 of the folder button 530 in the bottom bar 520. The folder screen 560 includes a list 562 of the folders 564 stored on the memory 220 of the photo-sharing device 200. The folder list 562 includes a folder photo 564a, which the processor 210 of the photo-sharing device 200 may automatically select and display or may be selected by the user 30. The list 562 also includes the folder name 564b selected by a user 30 and edit notes 564c, indicating when the folder 564 was last edited and by whom. Moreover, the folder screen 560 includes the top bar 540 having a create button 544. When the user 30 selects the create button 544, the user may create a new folder 564 and add photos 322 and/or videos 324 the folder.

Referring to FIG. 5D, when the user 30 selects the create button 544 from the folder screen 560, the application 400 displays a prompt 570 on the user display 302 that prompts the user 30 to enter a collection/folder name in an input box 572. When the user is ready to enter a name for the collection/folder 564, the user 30 selects the input box 572 and the application 400 displays a keyboard 574, allowing the user to type a name for the collection/folder 564. Once the user 30 completes entering a collection/folder name in the input box 572, the user 30 may select the create collection button 576 to create the new collection/folder 564. Once the user 30 selects the create collection button 576, the user may begin adding photos 322 and/or videos 324 to the created collection 564 as shown in FIG. 5E. The top bar 540 includes the name of the created collection 564; in this case, the user selected “8^{th} Wedding Anniversary” as the name of the collection 564. In some examples, each collection 564 includes multiple sub collections/folders. For example, photos 322 and/or videos 324 captured during your trip to Florida may include multiple sub folder each specific to an event in Florida, e.g., Lake Okeechobee trip, visiting with grandma, and a day at the beach. Therefore, when adding photos/videos to a collection 564, a user 30 may select a main folder 582 and a sub folder 584 from a search screen 580 (indicated by the indicator 521 together with the search icon 524). The user 30 may decide to locate photos 322 and/or videos 324 by history, location or folder and can therefore select one of the history icon 526, location icon 528, or folder icon 530 to find and add photo/videos to the newly created album 455.

Once the user 30 selects the folder/collection that he/she wants to add photos 322 and/or videos 324 to the newly created folder/collection, then the user 30 selects the take me back button 586, which allows the application 400 to display the results screen 590, as shown in FIG. 5F. The results screen 590 includes the name of the folder/sub-folder combination 592 and a back button 594 that takes the user 30 to the previous screen. The results screen 590 also includes a list 596 the photos 322 and/or videos 324 that are included in the selected folder 592. A user 30 may add photos 322 and/or videos 324 to the folder 455 by expanding the photo/video and performing a swiping/flinging motion on the user display screen 302 towards the name of the created folder 455, 564 as explained with respect to FIG. 5C. Moreover, the user 30 select the add button 598 to add the photo/video to the folder 455, 564.

FIGS. 6A-6H provide another method for viewing the photos 322 and/or videos 324 stored on the memory 220 of the photo-sharing device 200 using a user device 300. Referring to FIG. 6A, in some implementations, the user device 300 displays on its display 302 (via the application 400) a home screen 600 that includes a top bar 610. The top bar 610 includes the screen title 602 (e.g., Home), and settings icon 604, and a search icon 606. Moreover, the home screen 600 includes a list 620 of buttons that the user 30 may select to take an action. These buttons include a timeline button 622, a places button 624, a favorites button 626, a time travel button 628, and a collections button 630. Other buttons may also be possible.

When the user 30 selects the timeline button 622, the application 400 displays the photos 322 and/or videos 324 by timeline or chronological order. When the user 30 selects the places button 624, the application 400 displays a map screen 632 (FIG. 6B) with location icons 634 around the map showing a location where one or more photos 322 and/or videos 324 were captured. In some examples, the location icons 634 include the number of photos taken at that specific locations. The user 30 may scroll through places using a scroll or navigation icon 608.

When the user 30 selects the favorite button 626 on the home screen 600, the application 400 displays the photos 322 and/or videos 324 previously tagged as favorites by one or more users 30. In some examples, when the user 30 selects the time travel button 628, the user 30 may input a specific date or range of dates, and the application 400 displays all photos 322 and/or videos 324 captured on the specific date or the range of dates specified. Finally, if the user 30 selects the collections button 630 (folders), the application 400 displays all these folders/collections 455 created by one or more users 30.

In some implementations, when a user 30 selects the search button 606 from the home screen 600 or any other screen having a search button 606, the application 400 displays a search screen 640, as shown in FIG. 6C. The search screen 640 includes a search input box 642 for receiving an input from a user 30. When the user 30 selects the search input box 642, the application 400 displays a keyboard 574 allowing the user 30 to type the search criteria in the search input box 642. In some examples, the search screen 640 displays a list of buttons 644 associated with a user's favorites (e.g., Mom, Dad) or a specific event, or a date, or a location. Referring to FIG. 6D, when the user 30 starts entering letters and numbers in the search input box 642, then the application 400 reduces the number of buttons in the list of buttons 644 to only display the buttons relating to the search terms entered. For example, as shown in FIG. 6D, when the user 30 selected July 2013 then enters “PAR,” the application 400 reduces the list of buttons 644 to display “PARis” and “PARty,” which both relating to the search criteria.

Referring to FIG. 6E, in some implementations, when the user 30 is viewing a folder 455, e.g., “Trip to France” folder, the user 30 may also be viewing the sub-folder “Strolling around Paris.” The folder screen 650 includes a folder title 652, a subfolder title 654, an edit icon 656 (e.g., to edit a title 652, 654), and a scrolling list 658 of small representations of the photos 322 and/or videos 324 in the subfolder/folder 455. The user 30 may scroll through the scrolling list 658 and select of photo 322 and/or a video 324 from the scrolling list 658 to view it in the expanded view 660. In some examples, the expanded view 660 includes a comments/notes button 662. When the user 30 selects the comments/notes button 662, the application 400 displays a comments/notes input box 664 (FIG. 6F) that allows the user 30 to enter text. Thus, when the user 30 selects the comments/notes input box 664, the application 400 displays a keyboard 304 allowing the user 30 to input text in the comments/notes input box 664. The comments/notes input box 664 may include the name of the folder/subfolder 666 and an indicator 668 of the number of characters that a user 30 may enter in the comments/notes input box 664. The number in the indicator 668 decreases every time the user 30 enters a character in the comments/notes input box 664. The number of characters may be adjusted. Once the user 30 completes entering the text, the user 30 may select the save button 670 to save the description or the cancel button 672 to return to the previous screen and cancel the changes made.

Referring back to FIG. 6E, in some implementations, the photo-sharing application 400 displays an audio button 674. When a user selects the audio button 674, the user 30 may record an audio recording for association with the photo 322. The recording may be limited to a certain amount of time. The audio recording is similar to having a handwritten note on the back of a printed photograph. Thus, adding the audio recording captures not only and audio, but a person's voice that may be heard years after. The photo-sharing application 400 may associated the audio recording with the photo 322 and store both in the memory 220 of the photo-sharing device 200.

Referring to FIG. 6G, in some implementations, the home screen 600 includes a recent activity button (not shown), which when the user 30 selects, the application 400 displays a recent activity screen 676. The recent activity screen 676 includes a list of the recently viewed albums/collections, which may include the number of photos 322 and/or videos 324. The recent activity screen 676 may include a list of tags 678 that are associated with each collection/album.

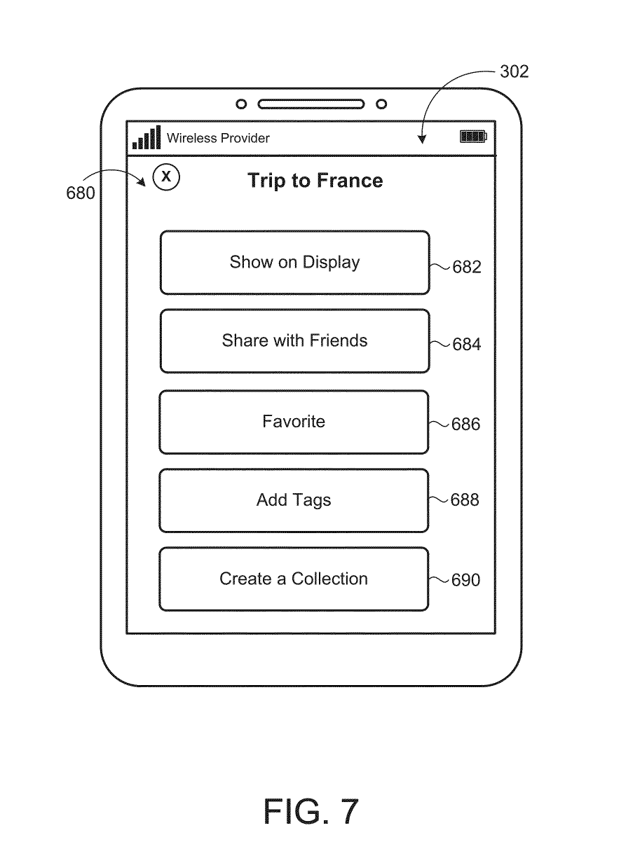

Referring to FIG. 7, in some implementations, prior to viewing a folder/collection 455, the display module 444 displays a user options screen 680 displaying user options, such as, but not limited to, a “show on display” option 682, a share with friends option 684, a favorites option 686, an add tags option 688, and create a collection option 690. The show on display option 682 displays the current collection on the display 332. The share with friends option 684 allows the user 30 to share a current collection 455 with other users 30 via the shared network with other user 30 or non-users (i.e., user who do not use the photo-sharing application 400). The favorite option 686 allows the user 30 to set the current collection/folder 455 as a favorite. The add tag 688 allows a user 30 to add tags to specific photos 322 and/or videos 324.

In some implementations, the photo-sharing system 100 may be a system of one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the photo-sharing system 200 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the photo-sharing system 100 may be configured to communicate with the network 10, 20. The one or more computing devices of the photo-sharing system 100 may also be configured to communicate with one another (e.g., via a shared network 20). The one or more computing devices may reside within a single machine at a single geographic location in some examples. In other examples, the one or more computing devices may reside within multiple machines at a single geographic location. In still other examples, the one or more computing devices of the photo-sharing system 100 may be distributed across a number of geographic locations.

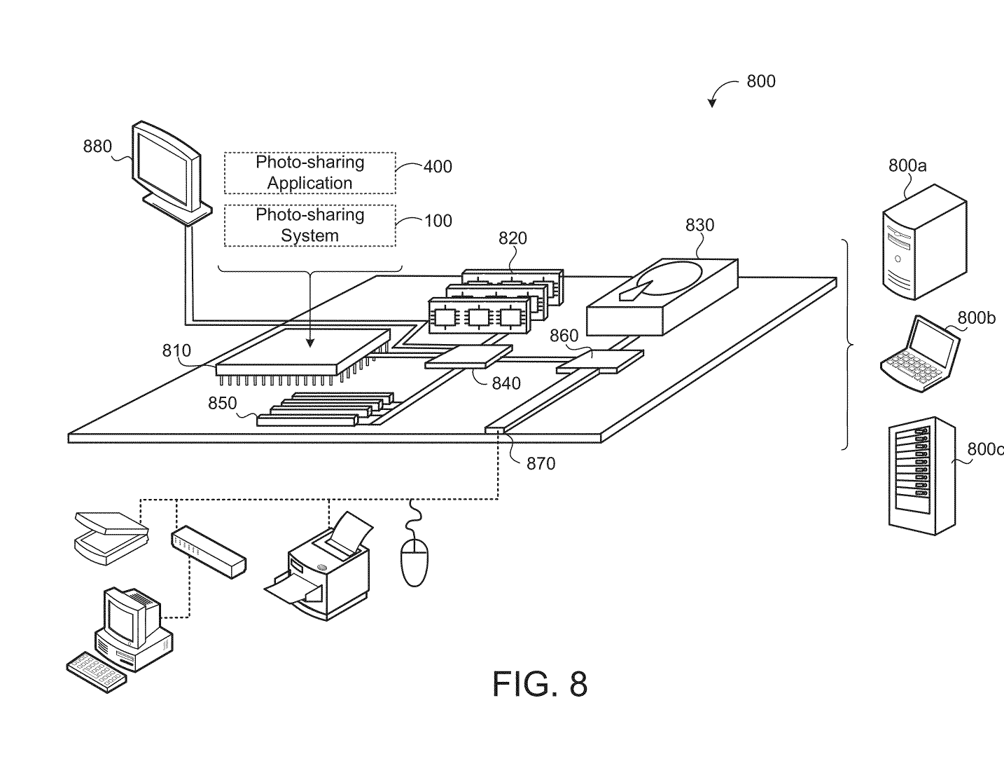

FIG. 8 is schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to low speed bus 870 and storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

As previously described, the memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and low-speed expansion port 870. The low-speed expansion port 870, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

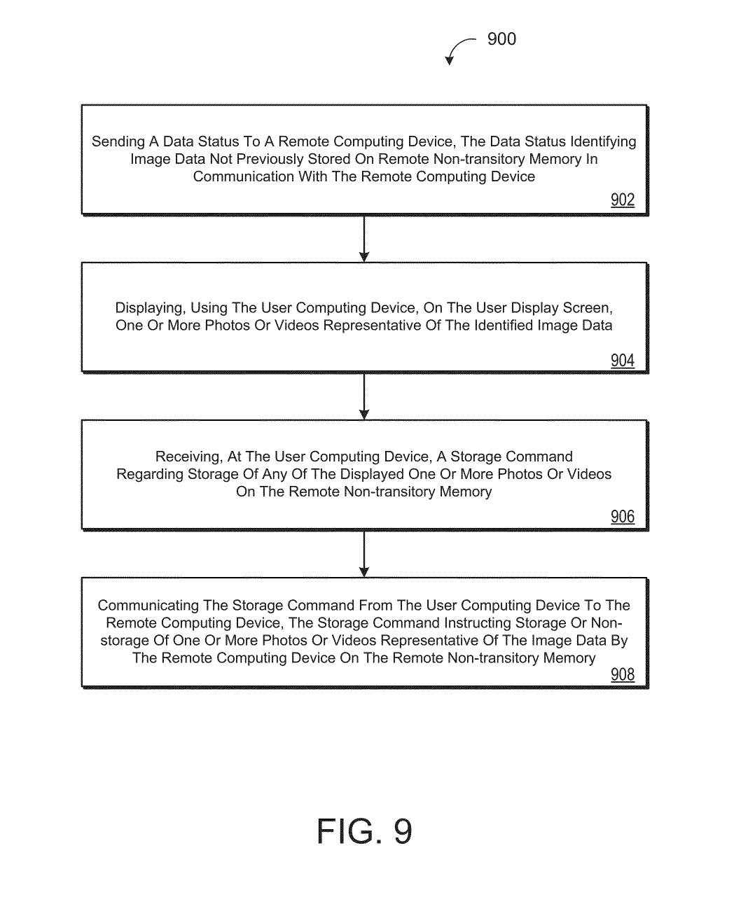

Referring to FIGS. 4 and 9, a method 900 of operating a user device 300 (e.g., computer, portable electronic device, smartphone, tablet PC, cellular telephone, portable digital assistant, digital camera, digital video camera) having a user computing device 310, user non-transitory memory 320 in communication with the user computing device 310, and a user display screen 302 in communication with the user computing device 310 includes, at block 902, sending a data status to a remote computing device 210 (e.g., of a photo-sharing device 200). The data status identifies image data (e.g., a photo 322 and/or a video 324) not previously stored on remote non-transitory memory 220 in communication with the remote computing device 210. Additionally or alternatively, the method 900 includes receiving, at the user computing device 310, a communication (e.g., a photo 322 and/or a video 324) from a remote computing device (e.g., a photo-sharing device 200) accessing the user non-transitory memory 320. The communication identifies image data (e.g., a photo 322 and/or a video 324) stored on the user non-transitory memory 320 not previously stored on remote non-transitory memory 220 in communication with the remote computing device 210. At block 904, the method 900 also includes, displaying, using the user computing device 310, on the user display screen 302, one or more photos 322 or videos 324 representative of the identified image data 322, 324, and receiving, at block 906, at the user computing device 310, a storage command 460 regarding storage of any of the displayed one or more photos 322 or videos 324 on the remote non-transitory memory 220. The method 900 also includes, at block 908, communicating the storage command 460 from the user computing device 310 to the remote computing device 210. The storage command 460 instructs storage or non-storage of one or more photos or videos 324 representative of the image data by the remote computing device 210 on the remote non-transitory memory 220.

Implementations of the disclosure may include one or more of the following features. In some implementations, the method 900 includes receiving, at the user computing device 310, an indication of available connectivity to a communication network (e.g., a local network 10 or a shared network 20), and establishing communication (e.g., wireless or wired via cable 50) between the user computing device 310 and the remote computing device 210 through the communication network 10, 20

The method may also include receiving, at the user computing device 310, a request from the remote computing device 210 to access image data stored on the user non-transitory memory 320. Additionally or alternatively, in some examples, the method 900 may further include allowing the remote computing device 210 to store the selected one or more photos 322 or videos 324 on the remote non-transitory memory 220, when the storage command 460 contains a selection of one or more photos 322 or videos 324 for storage on the remote non-transitory memory 220.

In some examples, the method 900 further includes disallowing the remote computing device 210 to store the selected one or more photos 322 or videos 324 on the remote non-transitory memory 220, when the storage command 460 contains a selection of one or more photos 322 or videos 324 for non-storage on the remote non-transitory memory 220. Additionally or alternatively, the storage command 460 may instruct the remote computing device 210 to alter the image data before storing the image data on the remote non-transitory memory 220. In some examples, the storage command 460 instructs the remote computing device 210 to alter image metadata of the identified image data before storing the image data on the remote non-transitory memory 220.

In some implementations, the method 900 further includes receiving, at the user computing device 310, an image manipulation command 462 for manipulating the identified image data stored on user non-transitory memory 320 before allowing storage of the identified image data on the remote non-transitory memory 220. Additionally or alternatively, the method may include receiving, at the user computing device 310, sound data from an audio device in communication with the user computing device 310; receiving a selection of one or more photos 322 or videos 324 representative of the identified image data; and associating the sound data with the selected one or more photos 322 or videos 324. The storage command 460 instructs storage of the sound data and the identified image data on the remote non-transitory memory 220.

The method 900 may also include receiving, at the user computing device 310, a selection of a photo 322 or video 324 and a touch gesture (FIG. 4B) on the user display screen 302 indicative of a swiping motion to move the selected one or more photos 322 or videos 324 to a remote display screen 332 in communication with the remote computing device 210. The swiping motion may include a forward motion toward the remote display screen 332 and away from the user device 300.

In some implementations, the method 900 includes displaying, using the user computing device 310, on the user display screen 302 a map view 632 (FIG. 6B) The map view 632 includes a map and a location icon 634 overlaid at a location on the map and indicative of a number of photos 322 or videos 324 captured at the location.

The method 900 may also include displaying, using the user computing device 310, on the user display screen 302 photos 322 or videos 324 representative of image data stored on the user non-transitory memory 320 and a storage state for each photo 322 or video 324. The storage state indicating whether the photo 322 or video 324 is currently stored on the remote non-transitory memory 220.

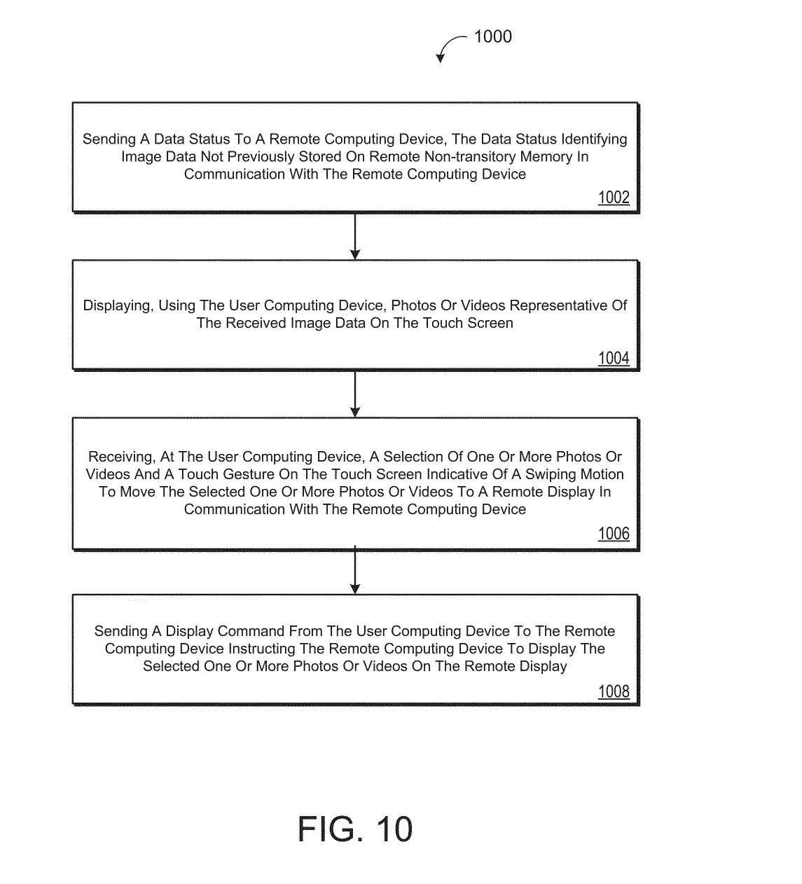

Referring to FIGS. 4 and 10, in some implementations, a method 1000 of operating a user device 300 having a user computing device 310, user non-transitory memory 320 in communication with the user computing device 310, and a touch screen 302 in communication with the user computing device 310 includes, at block 1002, sending a data status to a remote computing device (e.g., a photo-sharing device 200). The data status identifies image data (e.g., a photo 322 and/or a video 324) not previously stored on remote non-transitory memory 220 in communication with the remote computing device 210. Additionally or alternatively, the method 1000 includes receiving, at the user computing device 310, a communication from a remote computing device 210. The communication includes image data stored on remote non-transitory memory 220 in communication with the remote computing device 210. At block 1004, the method 1000 also includes displaying, using the user computing device 310, photos 322 or videos 324 representative of the received image data on the touch screen 302, and receiving, at block 1006, at the user computing device 310, a selection of one or more photos 322 or videos 324 and a touch gesture (FIG. 6B) on the touch screen 302 indicative of a swiping motion to move the selected one or more photos 322 or videos 324 to a remote display 332 in communication with the remote computing device 210. The method 1000 includes sending, at block 1008, a display command 464 from the user computing device 310 to the remote computing device 210 instructing the remote computing device 210 to display the selected one or more photos 322 or videos 324 on the remote display 332.

In some implementations, the touch gesture includes a substantially linear swipe along the touch screen 302. The substantially linear swipe along the touch screen 302 may include a linear swipe towards the remote display 332 and away from the user device 300.

In some examples, the method 1000 also includes receiving, at the user computing device 310, sound data from an audio device in communication with the user computing device 310 and receiving a selection of one or more photos 322 or videos 324. The method 1000 also includes associating, using the user computing device 310, the sound data (e.g., voice recording) with the selected one or more photos 322 or videos 324. The method 1000 may further include sending a storage command 460 from the user computing device 310 to the remote computing device 210 instructing the remote computing device 210 to store the sound data and the selected one or more photos 322 or videos 324 on the remote non-transitory memory 220. In some implementations, the method 1000 further includes sending a favorite command 466 from the user computing device 310 to the remote computing device 210 instructing the remote computing device 210 to associate a favorite tag 457, 507 with the selected one or more photos 322 or videos 324.

In some implementations, the method 1000 may include, when displaying a video 324 on the touch screen 302, displaying: a timeline T (FIG. 4C) indicative of a length Tₙ of the video 324; a favorite start icon 508a overlain on the timeline T and indicating a start of a favorite portion of the video 324; and a favorite end icon 508b overlain on the timeline T and indicating an end of the favorite portion of the video 324, the favorite start icon 508a and the favorite end icon 508b indicating a favorite video portion 508c of the video 324. The method 1000 may also include receiving, at the user computing device 310, a selection of a favorite start time on the timeline T of the video, and overlaying the favorite start icon on the timeline T at a time corresponding to the favorite start time. The method 1000 includes receiving, at the user computing device 310, a selection of a favorite end time T_{b} on the timeline T of the video, and overlaying the favorite end icon on the timeline T at a time corresponding to the favorite end time. In some examples, the method 1000 includes sending a view favorite video command 472 from the user computing device 310 to the remote computing device 210 instructing the remote computing device 210 to display the favorite video portion 508c on the remote display 332. Additionally or alternatively, the display command 464 may instruct the remote computing device 210 to display only the selected one or more photos 322 or videos 324 designated as favorite or public viewing on the remote display 332.

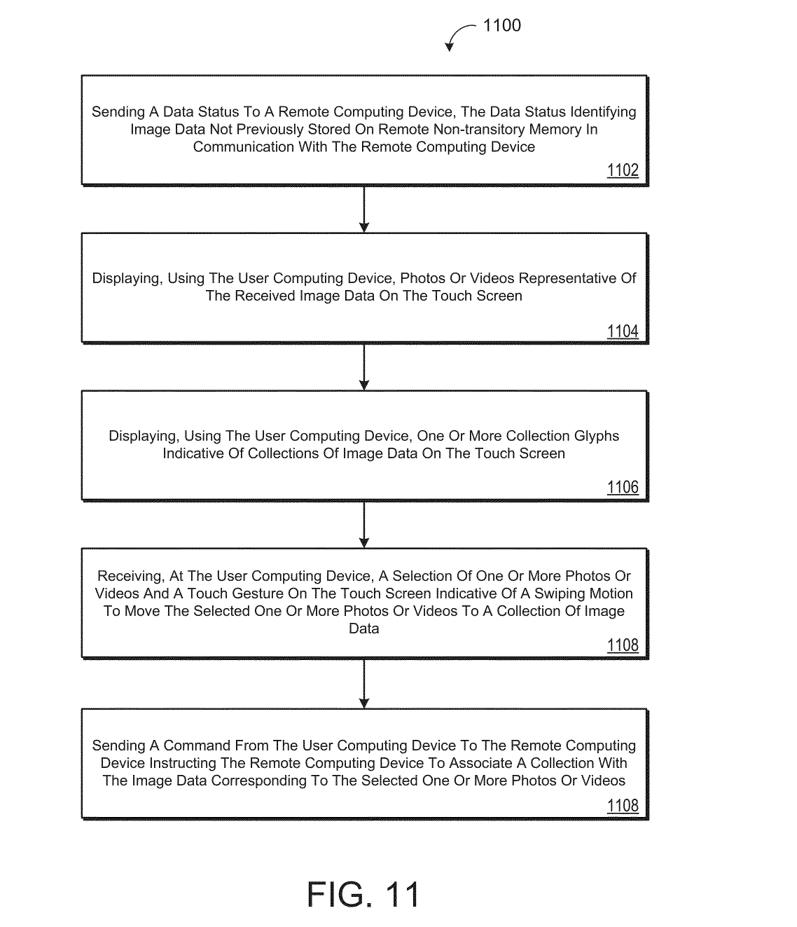

Referring to FIG. 11, in some implementations, a method 1100 of operating a user device 300 having a user computing device 310, user non-transitory memory 320 in communication with the user computing device 310, and a touch screen 302 in communication with the user computing device 310 includes, at block 1102, sending a data status to a remote computing device (e.g., a photo-sharing device 200). The data status identifies image data (e.g., a photo 322 and/or a video 324) not previously stored on remote non-transitory memory 220 in communication with the remote computing device 210. Additionally or alternatively, the method 1100 includes receiving, at the user computing device 310, a communication from a remote computing device 210. The communication includes image data stored on remote non-transitory memory 220 in communication with the remote computing device 210. At block 1104, the method 1100 also includes displaying, using the user computing device 310, photos 322 or videos 324 representative of the received image data on the touch screen 302, and displaying, at block 1106, one or more collection glyphs indicative of collections of image data on the touch screen 302. At block 1108, the method 1100 includes receiving, at the user computing device 310, a selection of one or more photos 322 or videos 324 and a touch gesture (FIG. 4B) on the touch screen 302 indicative of a swiping motion to move the selected one or more photos 322 or videos 324 to a collection of image data, and sending at block 1108 a command 461 from the user computing device 310 to the remote computing device 210 instructing the remote computing device 210 to associate a collection 455 (e.g., album or folder) with the image data corresponding to the selected one or more photos 322 or videos 324.

In some implementations, the method 1100 includes displaying with each photo 322 or video 324 any collection tags 457 currently associated with the photo 322 or video 324. The collections includes at least one of: a location collection for photos 322 or videos 324 captured at a similar geolocation; a favorite collection for photos 322 or videos 324 designated as a user favorite; or a multi-device collection for photos 322 or videos 324 associated with multiple user devices 300.

In some examples, the method 1100 includes receiving, at the user computing device 310, a collection creation command 470, and sending the collection creation command 470 from the user computing device 310 to the remote computing device 210. The collection creation command 470 instructs the remote computing device 210 to generate and associate the collection 455 with the image data corresponding to the selected one or more photos 322 or videos 324. The method 1100 may include a command 461 from the user computing device 310 to the remote computing device 210 instructing the remote computing device 210 to associate a favorite tag 457, 507 with the selected one or more photos 322 or videos 324.

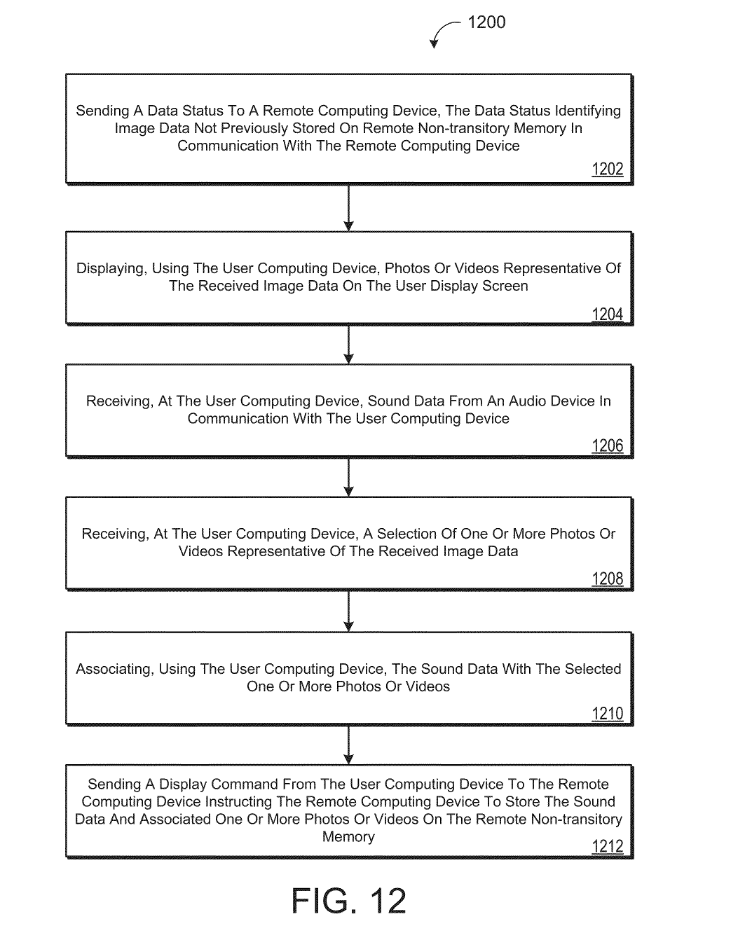

Referring to FIG. 12, in some implementations, a method 1200 of operating a user device 300 having a user computing device 310, user non-transitory memory 320 in communication with the user computing device 310, and a user display screen 302 in communication with the user computing device 310 includes, at block 1202, sending a data status to a remote computing device (e.g., a photo-sharing device 200). The data status identifies image data (e.g., a photo 322 and/or a video 324) not previously stored on remote non-transitory memory 220 in communication with the remote computing device 210. Additionally or alternatively, the method 1200 includes receiving, at the user computing device 310, a communication from a remote computing device 210. The communication includes image data stored on remote non-transitory memory 220 in communication with the remote computing device 210. At block 1204, the method 1200 includes displaying, using the user computing device 310, photos 322 or videos 324 representative of the received image data on the user display screen 302, and receiving, at block 1206, sound data (e.g., audio recording) from an audio device 303 in communication with the user computing device 310. At block 1208, the method 1200 also includes receiving, at the user computing device 310, a selection of one or more photos 322 or videos 324 representative of the received image data and associating, at block 1210, using the user computing device 310, the sound data with the selected one or more photos 322 or videos 324. The method 1200 includes sending, at block 1212, a display command 464 from the user computing device 310 to the remote computing device 210 instructing the remote computing device 210 to store the sound data and associated one or more photos 322 or videos 324 on the remote non-transitory memory 220.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method of operating a user device having a user computing device, user non-transitory memory in communication with the user computing device, and a user display screen in communication with the user computing device, the method comprising:
sending a data status to a remote computing device, the data status identifying image data not previously stored on remote non-transitory memory in communication with the remote computing device;
displaying, using the user computing device, on the user display screen, one or more photos or videos representative of the identified image data;
receiving, at the user computing device, a storage command regarding storage of any of the displayed one or more photos or videos on the remote non-transitory memory; and
communicating the storage command from the user computing device to the remote computing device, the storage command instructing storage or non-storage of one or more photos or videos representative of the image data by the remote computing device on the remote non-transitory memory.

2. The method of claim 1, further comprising:
receiving, at the user computing device, an indication of available connectivity to a communication network; and
establishing communication between the user computing device and the remote computing device through the communication network.

3. The method of claim 1, further comprising receiving, at the user computing device, a request from the remote computing device to access image data stored on the user non-transitory memory for retrieval.

4. The method of claim 1, further comprising, when the storage command contains a selection of one or more photos or videos for storage on the remote non-transitory memory, allowing the remote computing device to store the selected one or more photos or videos on the remote non-transitory memory.

5. The method of claim 1, further comprising, when the storage command contains a selection of one or more photos or videos for non-storage on the remote non-transitory memory, disallowing the remote computing device to store the selected one or more photos or videos on the remote non-transitory memory.

6. The method of claim 1, wherein the storage command instructs the remote computing device to alter the image data before storing the image data on the remote non-transitory memory.

7. The method of claim 1, wherein the storage command instructs the remote computing device to alter image metadata of the identified image data before storing the image data on the remote non-transitory memory.

8. The method of claim 1, further comprising receiving, at the user computing device, an image manipulation command for manipulating the identified image data stored on user non-transitory memory before allowing storage of the identified image data on the remote non-transitory memory.

9. The method of claim 1, further comprising:
receiving, at the user computing device, sound data from an audio device in communication with the user computing device;
receiving, at the user computing device, a selection of one or more photos or videos representative of the identified image data; and
associating, using the user computing device, the sound data with the selected one or more photos or videos.

10. The method of claim 9, wherein the storage command instructs storage of the sound data and the identified image data on the remote non-transitory memory.

11. The method of claim 1, further comprising receiving, at the user computing device, a selection of a photo or video and a touch gesture on the user display screen indicative of a swiping motion to move the selected one or more photos or videos to a remote display screen in communication with the remote computing device.

12. The method of claim 11, wherein the swiping motion includes a forward motion toward the remote display screen and away from the user device.

13. The method of claim 1, further comprising displaying, using the user computing device, on the user display screen a map view comprising:
a map; and
a location icon overlaid at a location on the map and indicative of a number of photos or videos captured at the location.

14. The method of claim 1, further comprising displaying, using the user computing device, on the user display screen photos or videos representative of image data stored on the user non-transitory memory and a storage state for each photo or video, the storage state indicating whether the photo or video is currently stored on the remote non-transitory memory.

15. A method of operating a user device having a user computing device, user non-transitory memory in communication with the user computing device, and a touch screen in communication with the user computing device, the method comprising:
sending a data status to a remote computing device, the data status identifying image data not previously stored on remote non-transitory memory in communication with the remote computing device;
displaying, using the user computing device, photos or videos representative of the received image data on the touch screen;
receiving, at the user computing device, a selection of one or more photos or videos and a touch gesture on the touch screen indicative of a swiping motion to move the selected one or more photos or videos to a remote display in communication with the remote computing device; and
sending a display command from the user computing device to the remote computing device instructing the remote computing device to display the selected one or more photos or videos on the remote display.

16. The method of claim 15, wherein the touch gesture comprises a substantially linear swipe along the touch screen.

17. The method of claim 16, wherein the substantially linear swipe along the touch screen comprises a linear swipe towards the remote display and away from the user device.

18. The method of claim 15, further comprising:
receiving, at the user computing device, sound data from an audio device in communication with the user computing device;
receiving, at the user computing device, a selection of one or more photos or videos; and
associating, using the user computing device, the sound data with the selected one or more photos or videos.

19. The method of claim 18, further comprising sending a storage command from the user computing device to the remote computing device instructing the remote computing device to store the sound data and the selected one or more photos or videos on the remote non-transitory memory.

20. The method of claim 15, further comprising sending a favorite command from the user computing device to the remote computing device instructing the remote computing device to associate a favorite tag with the selected one or more photos or videos.

21. The method of claim 15, further comprising, when displaying a video on the touch screen, displaying:
a timeline indicative of a length of the video;
a favorite start icon overlain on the timeline and indicating a start of a favorite portion of the video; and
a favorite end icon overlain on the timeline and indicating and end of the favorite portion of the video, the favorite start icon and the favorite end icon indicating a favorite video portion of the video.

22. The method of claim 21, further comprising:
receiving, at the user computing device, a selection of a favorite start time on the timeline of the video;
overlaying the favorite start icon on the timeline at a time corresponding to the favorite start time;
receiving, at the user computing device, a selection of a favorite end time on the timeline of the video; and
overlaying the favorite end icon on the timeline at a time corresponding to the favorite end time.

23. The method of claim 22, further comprising sending a view favorite video command from the user computing device to the remote computing device instructing the remote computing device to display the favorite video portion on the remote display.

24. The method of claim 15, wherein the display command instructs the remote computing device to display only the selected one or more photos or videos designated as favorite or public viewing on the remote display.

25. A method of operating a user device having a user computing device, user non-transitory memory in communication with the user computing device, and a touch screen in communication with the user computing device, the method comprising:
sending a data status to a remote computing device, the data status identifying image data not previously stored on remote non-transitory memory in communication with the remote computing device;
displaying, using the user computing device, photos or videos representative of the received image data on the touch screen;
displaying, using the user computing device, one or more collection glyphs indicative of collections of image data on the touch screen;
receiving, at the user computing device, a selection of one or more photos or videos and a touch gesture on the touch screen indicative of a swiping motion to move the selected one or more photos or videos to a collection of image data; and
sending a command from the user computing device to the remote computing device instructing the remote computing device to associate a collection with the image data corresponding to the selected one or more photos or videos.

26. The method of claim 25, further comprising displaying with each photo or video any collection tags currently associated with the photo or video.

27. The method of claim 25, wherein the collections comprise at least one of:
a location collection for photos or videos captured at a similar geolocation;
a favorite collection for photos or videos designated as a user favorite; or
a multi-device collection for photos or videos associated with multiple user devices.

28. The method of claim 25, further comprising:
receiving, at the user computing device, a collection creation command; and
sending the collection creation command from the user computing device to the remote computing device, the collection creation command instructing the remote computing device to generate and associate the collection with the image data corresponding to the selected one or more photos or videos.

29. The method of claim 25, further comprising sending a command from the user computing device to the remote computing device instructing the remote computing device to associate a favorite tag with the selected one or more photos or videos.

30. A method of operating a user device having a user computing device, user non-transitory memory in communication with the user computing device, and a user display screen in communication with the user computing device, the method comprising:
sending a data status to a remote computing device, the data status identifying image data not previously stored on remote non-transitory memory in communication with the remote computing device;
displaying, using the user computing device, photos or videos representative of the received image data on the user display screen;
receiving, at the user computing device, sound data from an audio device in communication with the user computing device;
receiving, at the user computing device, a selection of one or more photos or videos representative of the received image data;
associating, using the user computing device, the sound data with the selected one or more photos or videos; and
sending a display command from the user computing device to the remote computing device instructing the remote computing device to store the sound data and associated one or more photos or videos on the remote non-transitory memory.
